(19) United States
(12) Patent Application Publication
(10) Pub. No.: US 2016/0364072 A1
(43) Pub. Date: Dec. 15, 2016

(54) IN-CELL TOUCH PANEL

(71) Applicant: Raydium Semiconductor Corporation, Hsinchu (TW)

(72) Inventors: Chang-Ching Chiang, Taichung City (TW); Yi-Ying Lin, Hualien City (TW); Kun-Pei Lee, Zhunan Township (TW)

(21) Appl. No.: 15/177,126

(22) Filed: Jun. 8, 2016

Related U.S. Application Data
(63) Continuation-in-part of application No. 14/858,457, filed on Sep. 18, 2015.
(60) Provisional application No. 62/174,740, filed on Jun. 12, 2015.

(51) Int. Cl. G06F 3/041; G09G 3/36; G02F 1/1343; G02F 1/1368; G02F 1/1335; G06F 3/044; G02F 1/1333

(52) U.S. Cl. CPC G06F 3/0416; G06F 3/044; G06F 3/0412; G09G 3/3677; G09G 3/3696; G02F 1/13338; G02F 1/1368; G02F 1/133514; G02F 1/133345; G02F 1/133512; G02F 1/134309; G06F 2203/04111; G06F 2203/04112; G09G 2300/0809

(57) ABSTRACT

An in-cell touch panel is disclosed. The in-cell touch panel includes a plurality of pixels. A laminated structure of each pixel includes a substrate, a TFT layer, a liquid crystal layer, a color filter layer and a glass layer. The TFT layer is disposed on the substrate. A first conductive layer and a common electrode are disposed in the TFT layer. The first conductive layer is arranged in mesh type or arranged along a first direction within an active area of the in-cell touch panel. The liquid crystal layer is disposed above the TFT layer. The color filter layer is disposed above the liquid crystal layer. The glass layer is disposed above the color filter layer.

### BACKGROUND OF THE INVENTION

Field of the Invention

This invention relates to a touch panel, especially to an in-cell touch panel.

Description of the Related Art

In general, there are several different laminated structures of the capacitive touch panel, for example, an on-cell capacitive touch panel or an in-cell capacitive touch panel.

Please refer to FIG. 1 and FIG. 2. FIG. 1 and FIG. 2 illustrate two different laminated structures of the on-cell capacitive touch panel and the in-cell capacitive touch panel respectively. As shown in FIG. 1, the laminated structure 1 of the on-cell capacitive touch panel includes a substrate 10, a thin-film transistor layer 11, a liquid crystal layer 12, a color filtering layer 13, a glass layer 14, a touch sensing layer 15, a polarizer 16, an adhesive 17, and top lens 18. As shown in FIG. 2, the laminated structure 2 of the in-cell capacitive touch panel includes a substrate 20, a thin-film transistor layer 21, a touch sensing layer 22, a liquid crystal layer 23, a color filtering layer 24, a glass layer 25, a polarizer 26, an adhesive 27, and top lens 28.

After comparing FIG. 1 with FIG. 2, it can be found that the touch sensing layer 22 of the in-cell capacitive touch panel is disposed under the liquid crystal layer 23; that is to say, the touch sensing layer 22 is disposed in the liquid crystal display module of the in-cell capacitive touch panel. On the other hand, the touch sensing layer 15 of the on-cell capacitive touch panel is disposed above the glass layer 14; that is to say, the touch sensing layer 15 is disposed out of the liquid crystal display module of the on-cell capacitive touch panel. Therefore, compared to the conventional one glass solution (OGS) and on-cell capacitive touch panel, the in-cell capacitive touch panel can achieve thinnest touch panel design and widely used in portable electronic products such as mobile phones, tablet PCs, and notebooks.

Therefore, the invention provides an in-cell touch panel having novel layout methods to reduce the effects of resistance and parasitic capacitance and enhance the entire performance of the in-cell touch panel.

### SUMMARY OF THE INVENTION

An embodiment of the invention is an in-cell touch panel. In this embodiment, the in-cell touch panel includes a plurality of pixels. A laminated structure of each pixel includes a substrate, a TFT layer, a liquid crystal layer, a color filter layer and a glass layer. The TFT layer is disposed on the substrate. A first conductive layer and a common electrode are disposed in the TFT layer. The first conductive layer is arranged in mesh type or arranged along a first direction within an active area of the in-cell touch panel. The liquid crystal layer is disposed above the TFT layer. The color filter layer is disposed above the liquid crystal layer. The glass layer is disposed above the color filter layer.

In an embodiment, the in-cell touch panel is an in-cell self-capacitive touch panel or an in-cell mutual-capacitive touch panel.

In an embodiment, touch electrodes of the in-cell touch panel is formed by the first conductive layer arranged in mesh type.

In an embodiment, the first conductive layer and the common electrode are separated by an insulating layer.

In an embodiment, a part of the first conductive layer not forming touch electrodes is electrically connected with the common electrode through a via.

In an embodiment, the first conductive layer is formed after the common electrode.

In an embodiment, the first conductive layer is formed before the common electrode.

In an embodiment, the color filter layer comprises a color filter and a black matrix resist having good light resistance, and the first conductive layer is disposed under the black matrix resist.

In an embodiment, if the in-cell touch panel is a hybrid in-cell touch panel, then the laminated structure further comprises a second conductive layer disposed at an inner side or an outer side of the glass layer, and the second conductive layer is arranged in mesh type or arranged along a second direction within the active area of the in-cell touch panel.

In an embodiment, the first conductive layer and the second conductive layer form a plurality of first direction touch electrodes and a plurality of second direction touch electrodes of the in-cell touch panel respectively.

In an embodiment, the plurality of first direction touch electrodes is touch driving electrodes and the plurality of second direction touch electrodes is touch sensing electrodes, or the plurality of first direction touch electrodes is touch sensing electrodes and the plurality of second direction touch electrodes is touch driving electrodes.

In an embodiment, at least one multi-functional electrode is disposed between the plurality of first direction touch electrodes and the plurality of second direction touch electrodes.

In an embodiment, the color filter layer comprises a color filter and a black matrix resist having good light resistance, and when the second conductive layer is arranged in mesh type and disposed at the inner side of the glass layer, the second conductive layer is disposed under the black matrix resist.

In an embodiment, when the second conductive layer is disposed at the inner side of the glass layer, the second conductive layer is a transparent conductive layer formed between the color filter layer and the glass layer.

In an embodiment, the second conductive layer is disposed at the outer side of the glass layer, the second conductive layer is a transparent conductive layer directly formed on the glass layer or disposed on the glass layer in a plug way.

In an embodiment, a switching unit is disposed out of the active area of the in-cell touch panel, and the part of the first conductive layer not forming touch electrodes and electrically connecting with the common electrode is not coupled to the switching unit.

In an embodiment, a switching unit is disposed out of the active area of the in-cell touch panel, and the switching unit is coupled to a plurality of touch electrodes of the in-cell touch panel to control the plurality of touch electrodes to be coupled to a signal line or to be disconnected in a floating state.

In an embodiment, the signal line is a source line fan-out or a gate line fan-out disposed out of the active area.

In an embodiment, when the plurality of touch electrodes is coupled to the signal line, a touch signal, a DC (Direct current) signal or a ground signal can be inputted through the signal line.

In an embodiment, the switching unit comprises a reference voltage signal, when the plurality of touch electrodes is disconnected, the plurality of touch electrodes is electrically connected with the reference voltage signal.

In an embodiment, the switching unit controls the signal line to output a touch signal to all or a part of the plurality of touch electrodes to achieve a combined touch sensing function or a zoning touch sensing function respectively.

In an embodiment, a switching unit is disposed out of the active area of the in-cell touch panel, and the switching unit is coupled to a source line or a gate line in the active area of the in-cell touch panel to control the source line or the gate line to be coupled to a display control signal input terminal or a other signal input terminal.

In an embodiment, the display control signal input terminal is a source line fan-out or a gate line fan-out.

In an embodiment, the other signal input terminal is a signal line and a DC (Direct current) signal, an AC (Alternating current) signal, a ground signal or a floating signal can be inputted through the signal line.

In an embodiment, the switching unit comprises a reference voltage signal, when the source line or the gate line is disconnected, the source line or the gate line is electrically connected with the reference voltage signal.

In an embodiment, the switching unit controls the signal line to output a touch signal to all or a part of the plurality of touch electrodes to achieve a combined touch sensing function or a zoning touch sensing function respectively.

In an embodiment, a switching unit is disposed out of the active area of the in-cell touch panel, and the switching unit is coupled to a source line or a gate line in the active area of the in-cell touch panel to control the source line or the gate line to be coupled to a display control signal input terminal or a other signal input terminal.

In an embodiment, the display control signal input terminal is a source line fan-out or a gate line fan-out.

In an embodiment, the other signal input terminal is a signal line and a DC (Direct current) signal, an AC (Alternating current) signal, a ground signal or a floating signal can be inputted through the signal line.

In an embodiment, the switching unit comprises a reference voltage signal, when the source line or the gate line is disconnected, the source line or the gate line is electrically connected with the reference voltage signal.

In an embodiment, at least one driver is disposed out of the active area of the in-cell touch panel and the at least one driver is formed by integrating a display driver and a touch driver or the display driver and the touch driver are disposed independently.

In an embodiment, a plurality of touch electrodes of the in-cell touch panel is all coupled to the at least one driver through a plurality of switching units disposed out of the active area of the in-cell touch panel.

In an embodiment, a part of the touch electrodes of the in-cell touch panel is coupled to the at least one driver through a plurality of switching units disposed out of the active area of the in-cell touch panel, and another part of the touch electrodes of the in-cell touch panel is directly coupled to the at least one driver.

In an embodiment, the at least one driver is formed on the substrate through COG (Chip on glass) encapsulation technology, COF (chip on film) encapsulation technology or GOA (Gate driver on array) encapsulation technology.

Compared to the prior art, the in-cell touch panel of the invention has the following advantages:
(1) The designs of the touch electrodes and their traces are simple.
(2) The original aperture ratio of the display apparatus is not affected by its layout method.
(3) The RC loading of the common electrode can be reduced.
(4) When the in-cell touch panel is operated in the touch mode, the common electrode will be controlled at the same time to reduce the entire RC loading of the in-cell touch panel.
(5) The touch mode and the display mode are driven in a time-sharing way to enhance the signal-noise ratio (SNR).
(6) The number of traces can be reduced to increase the degree of freedom of layout and the narrow border effect can be achieved.
(7) Less IC pins will be used.

The advantage and spirit of the invention may be understood by the following detailed descriptions together with the appended drawings.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 and FIG. 2 illustrate schematic diagrams of the laminated structures of the on-cell capacitive touch panel and the in-cell capacitive touch panel respectively.

FIG. 3 illustrates a cross-sectional schematic diagram of the laminated structure of the in-cell touch panel in a preferred embodiment of the invention.

FIG. 4 illustrates a schematic diagram of the laminated structure of the in-cell touch panel in another preferred embodiment of the invention.

FIG. 5˜FIG. 8 illustrate different embodiments of the second conductive layer disposed at the inner side or the outer side of the glass layer when the first conductive layer of the hybrid in-cell touch panel is formed after the common electrode respectively.

FIG. 9˜FIG. 12 illustrate different embodiments of the second conductive layer disposed at the inner side or the outer side of the glass layer when the first conductive layer of the hybrid in-cell touch panel is formed before the common electrode respectively.

FIG. 13˜FIG. 16 illustrate different embodiments of the connection ways of the traces of the switching units in the in-cell touch panel respectively.

FIG. 17A illustrates a schematic diagram of the first switching unit driving method of the in-cell touch panel of the invention; FIG. 17B illustrates a timing diagram of the signals operated in the display mode and touch sensing mode respectively.

FIG. 18 illustrates a schematic diagram of the second switching unit driving method of the in-cell touch panel of the invention.

FIG. 19A illustrates a schematic diagram of the third switching unit driving method of the in-cell touch panel of the invention; FIG. 19B illustrates a timing diagram of the signals operated in the display mode and touch sensing mode respectively.

FIG. 20A and FIG. 20B illustrate schematic diagrams of the fourth switching unit driving method of the in-cell touch panel of the invention respectively.

FIG. 21A˜FIG. 21D illustrate schematic diagrams of the laminated structure and the fifth switching unit driving method of the in-cell touch panel of the invention respectively.

FIG. 22A illustrates a schematic diagram of the sixth switching unit driving method of the in-cell touch panel of the invention; FIG. 22B illustrates a timing diagram of the signals operated in the display mode and touch sensing mode respectively.

FIG. 23A˜FIG. 23E illustrate a schematic diagram of the seventh switching unit driving method of the in-cell touch panel of the invention, a timing diagram of the signals operated in the display mode and touch sensing mode respectively and a schematic diagram of the touch electrode driving condition under different touch times.

FIG. 24A˜FIG. 24E illustrate a schematic diagram of the eighth switching unit driving method of the in-cell touch panel of the invention, a timing diagram of the signals operated in the display mode and touch sensing mode respectively and a schematic diagram of the touch electrode driving condition under different touch times.

FIG. 25A˜FIG. 25C illustrate schematic diagrams of the touch driving IC independently disposed out of the gate driving IC and display driving IC in the in-cell touch panel having the mutual-capacitive bridging structure, the hybrid mutual-capacitive structure and the single-layer mutual-capacitive structure respectively.

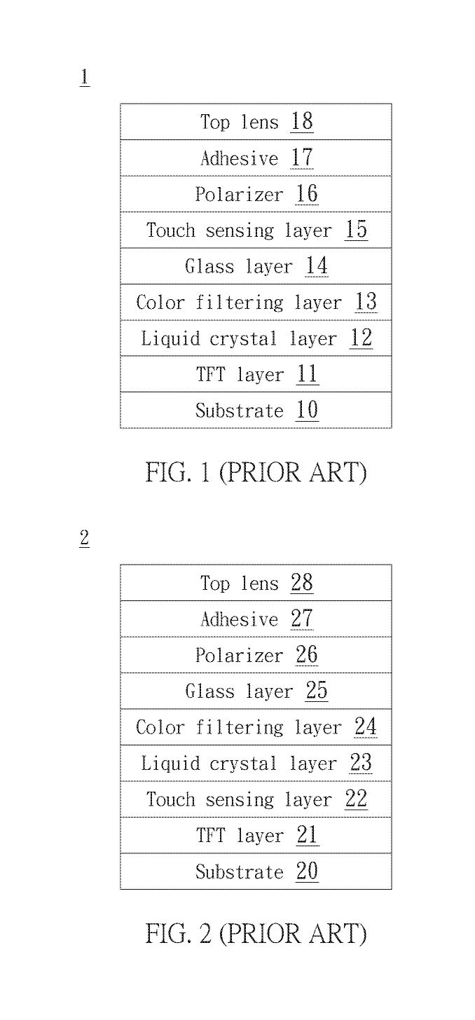

### DETAILED DESCRIPTION

A preferred embodiment of the invention is an in-cell touch panel. In fact, since the in-cell touch panel can achieve thinnest touch panel design, it can be widely used in portable electronic products such as mobile phones, tablet PCs and notebooks. It should be noticed that the in-cell touch panel of the invention can be an in-cell self-capacitive touch panel or an in-cell mutual-capacitive touch panel without any specific limitations.

In this embodiment, the in-cell touch panel includes a plurality of pixels. A laminated structure of each pixel includes a substrate, a TFT layer, a liquid crystal layer, a color filter layer and a glass layer. The TFT layer is disposed on the substrate. The liquid crystal layer is disposed above the TFT layer. The color filter layer is disposed above the liquid crystal layer. The glass layer is disposed above the color filter layer. It should be noticed that a first conductive layer and a common electrode are disposed in the TFT layer. The first conductive layer is arranged in mesh type or arranged along a first direction within an active area of the in-cell touch panel. A plurality of touch electrodes in the in-cell touch panel of the invention is formed by the first conductive layer arranged in mesh type. The first conductive layer and the common electrode can be separated by an insulating layer.

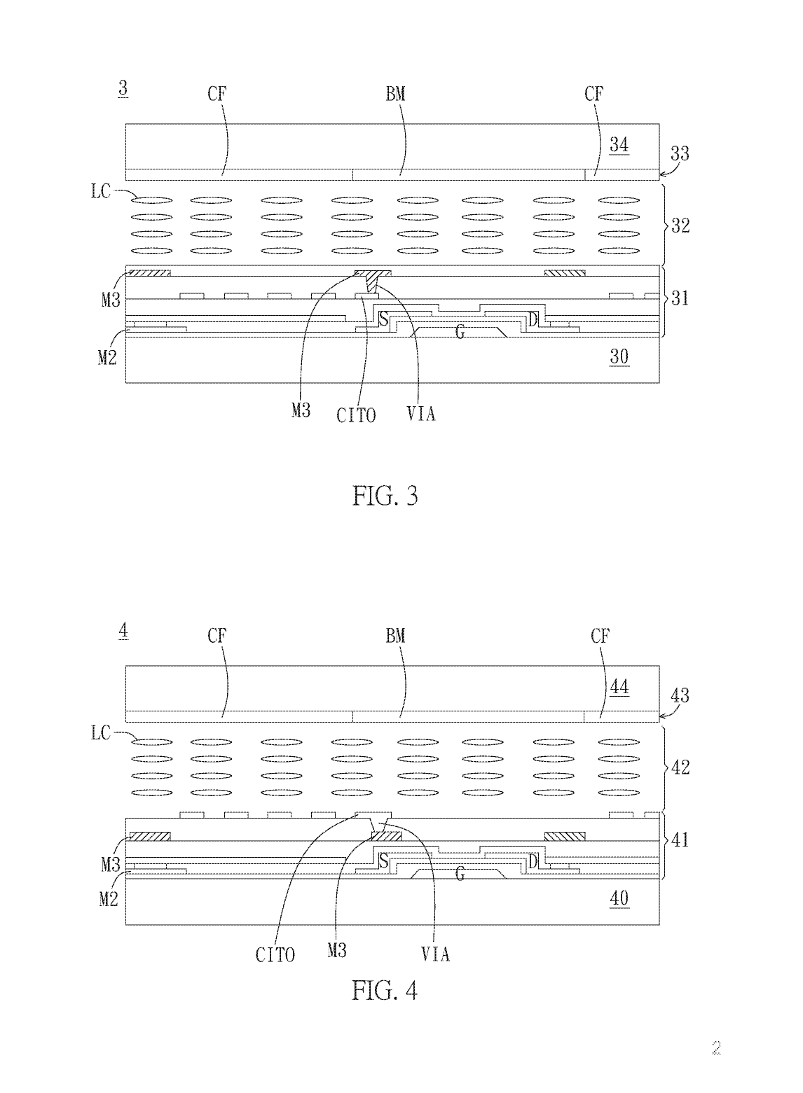

Then, please refer to FIG. 3. FIG. 3 illustrates a cross-sectional schematic diagram of the laminated structure of the in-cell touch panel in a preferred embodiment of the invention. As shown in FIG. 3, the laminated structure 3 of the in-cell touch panel includes a substrate 30, a TFT layer 31, a liquid crystal layer 32, a color filter layer 33 and a glass layer 34. The color filter layer 33 includes a color filter CF and a black matrix resist BM. The black matrix resist BM having good light resistance can be applied in the color filter layer 33 as the material of the color filter separating the three colors: red (R), green (G) and blue (B).

In this embodiment, the first conductive layer M3 and the common electrode CITO are disposed in the TFT layer 31, and the first conductive layer M3 is formed after the common electrode CITO. The first conductive layer M3 can be arranged in mesh type or only arranged along a first direction in the active area of the in-cell touch panel. The first conductive layer M3 is disposed under the black matrix resist BM and shielded by the black matrix resist BM. It should be noticed that a part of the first conductive layer M3 electrically connected with the common electrode CITO through the via VIA formed in the insulting layer in FIG. 3 will not be used as the touch electrodes of the in-cell touch panel.

Then, please refer to FIG. 4. FIG. 4 illustrates a cross-sectional schematic diagram of the laminated structure of the in-cell touch panel in another preferred embodiment of the invention. As shown in FIG. 4, the laminated structure 4 of the in-cell touch panel includes a substrate 40, a TFT layer 41, a liquid crystal layer 42, a color filter layer 43 and a glass layer 44. The color filter layer 43 includes a color filter CF and a black matrix resist BM. The black matrix resist BM having good light resistance can be applied in the color filter layer 43 as the material of the color filter separating the three colors: red (R), green (G) and blue (B).

In this embodiment, the first conductive layer M3 and the common electrode CITO are disposed in the TFT layer 41, and the first conductive layer M3 is formed before the common electrode CITO. The first conductive layer M3 can be arranged in mesh type or only arranged along a first direction in the active area of the in-cell touch panel. The first conductive layer M3 is disposed under the black matrix resist BM and shielded by the black matrix resist BM. It should be noticed that a part of the first conductive layer M3 electrically connected with the common electrode CITO through the via VIA formed in the insulting layer in FIG. 4 will not be used as the touch electrodes of the in-cell touch panel. In addition, if the in-cell touch panel is a hybrid in-cell touch panel, then the laminated structure disclosed in the above-mentioned embodiments can further include a second conductive layer, and the second conductive layer can be disposed at the inner side or the outer side of the glass layer 34 in FIG. 3 or the glass layer 44 in FIG. 4.

In fact, the second conductive layer can be arranged in mesh type or arranged in a second direction in the active area of the in-cell touch panel, so that the first conductive layer and the second conductive layer can form a plurality of first direction touch electrodes and a plurality of second direction touch electrodes respectively. In addition, at least one multi-function electrode can be disposed between the plurality of first direction touch electrodes and the plurality of second direction touch electrodes, but not limited to this. For example, when the in-cell touch panel is an in-cell mutual-capacitive touch panel, the plurality of first direction touch electrodes formed by the first conductive layer is used as touch driving electrodes and the plurality of second direction touch electrodes formed by the second conductive layer is used as touch sensing electrodes, or the plurality of first direction touch electrodes formed by the first conductive layer is used as touch sensing electrodes and the plurality of second direction touch electrodes formed by the second conductive layer is used as touch driving electrodes.

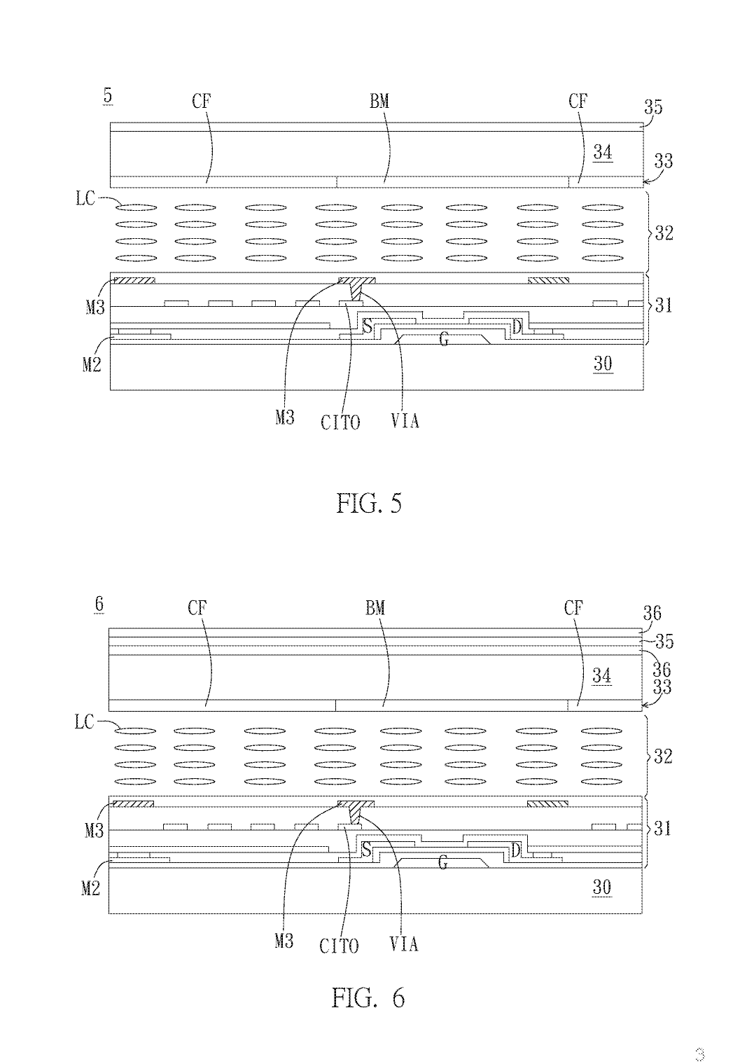

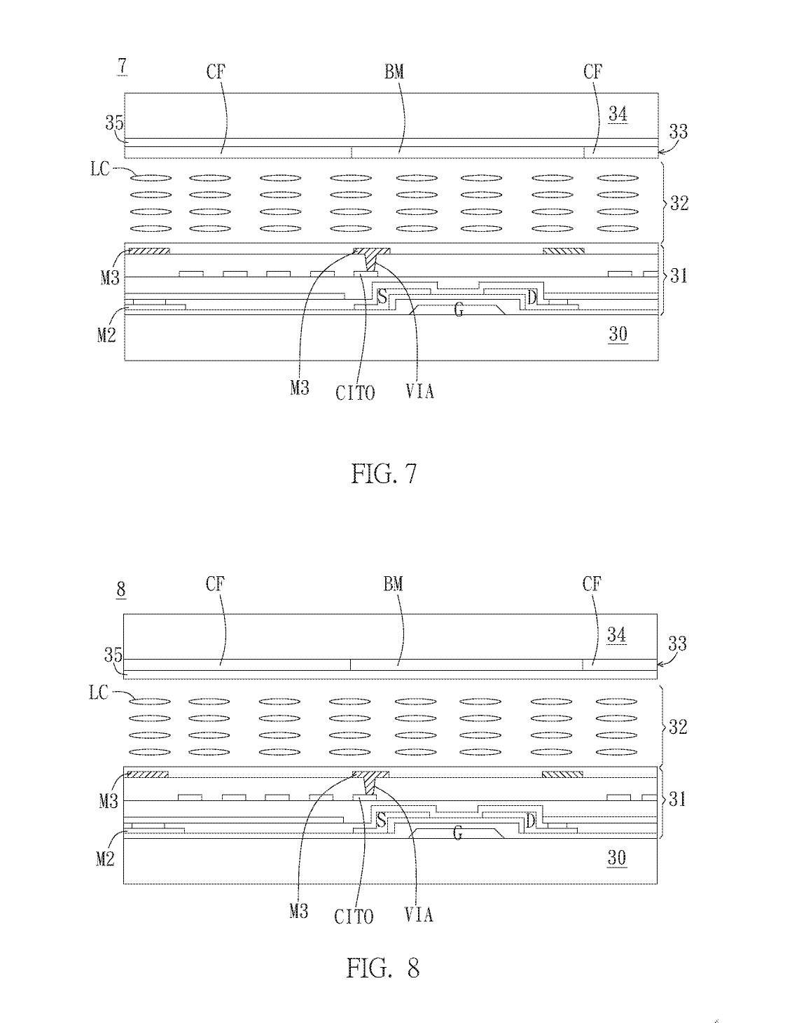

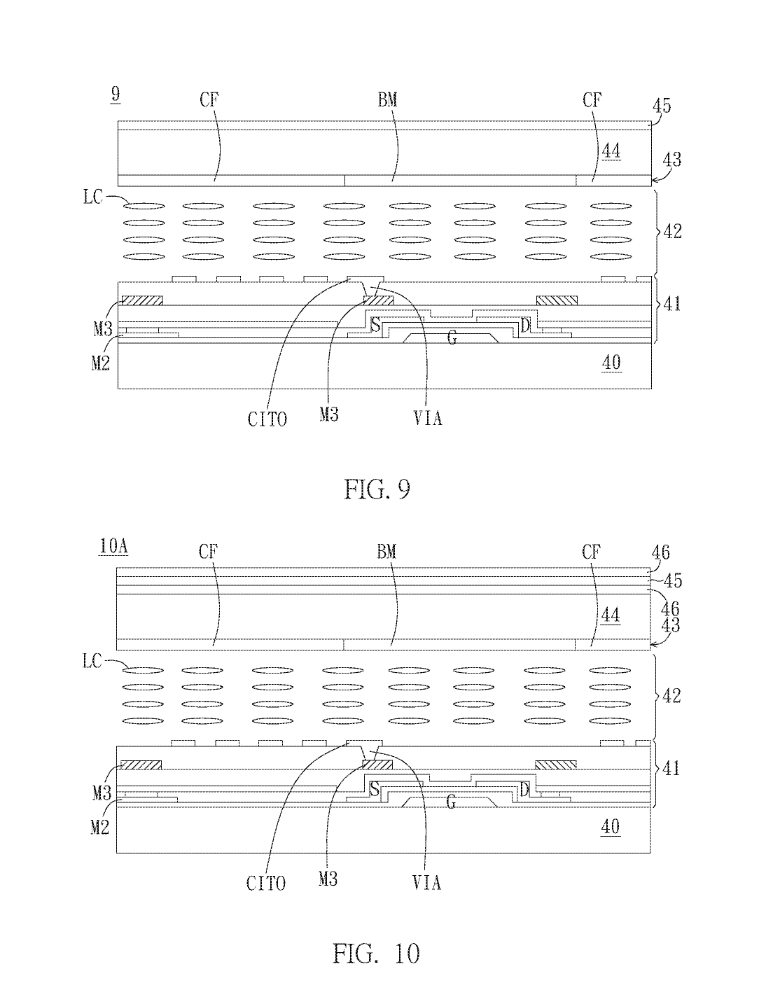

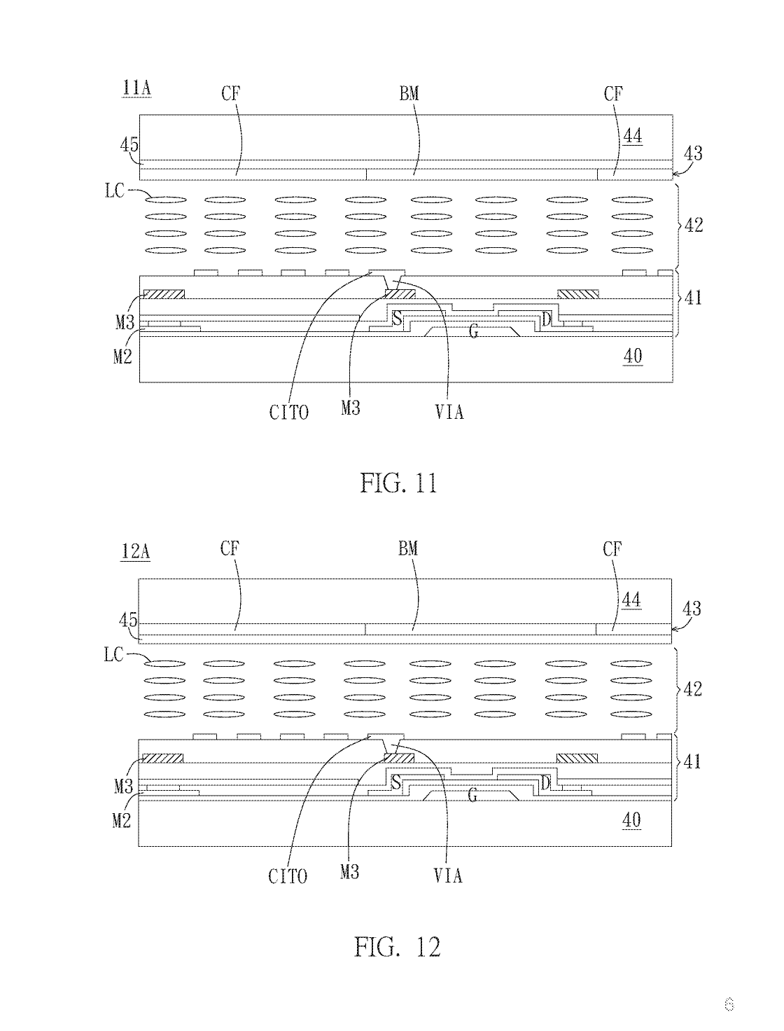

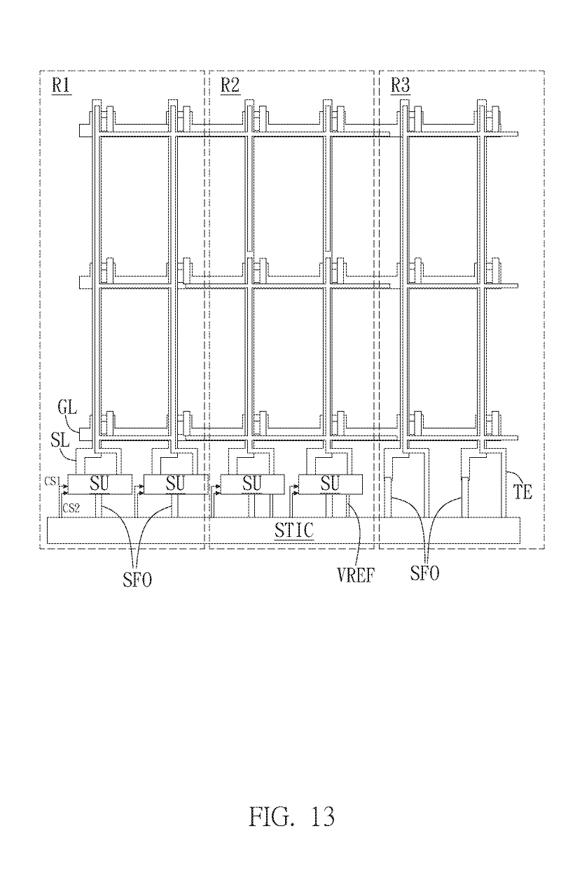

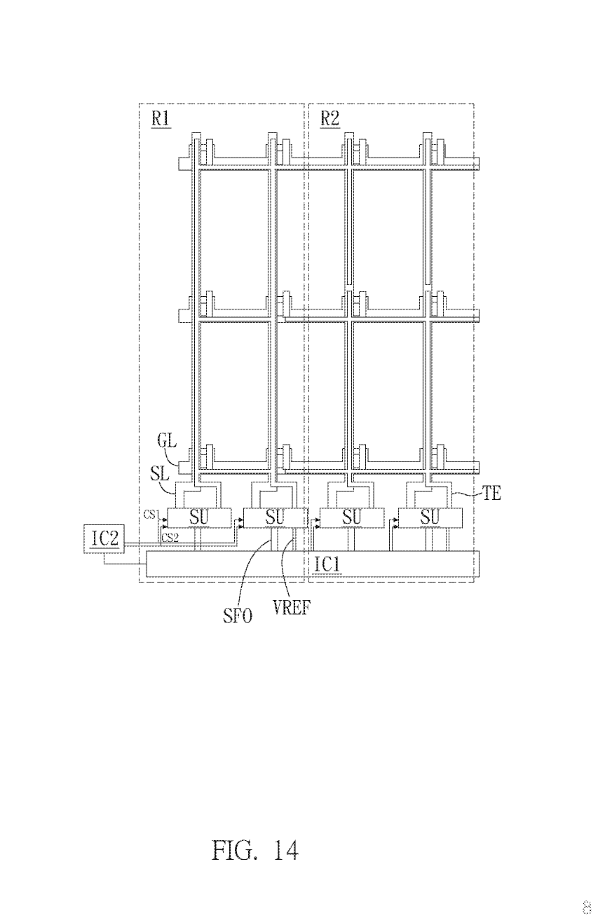

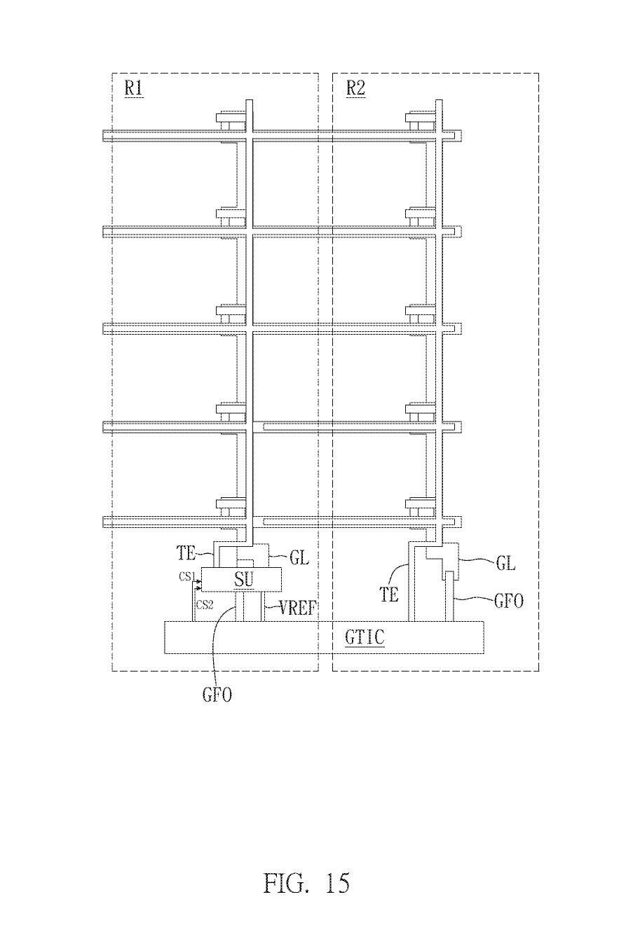

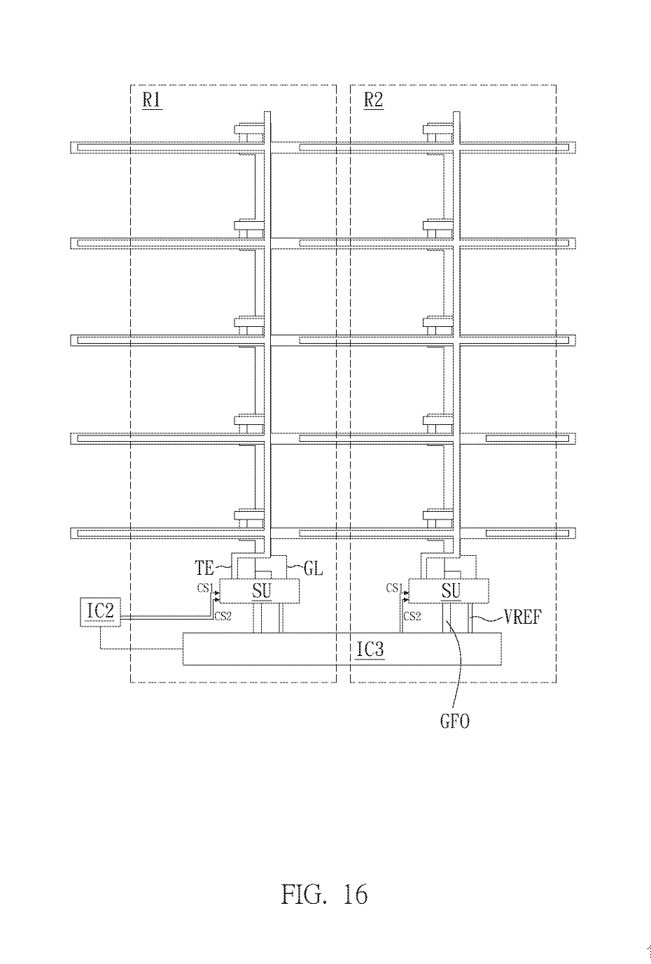

Please refer to FIG. 5˜FIG. 8. FIG. 5˜FIG. 8 illustrate different embodiments of the second conductive layer disposed at the inner side or the outer side of the glass layer when the first conductive layer of the hybrid in-cell touch panel is formed after the common electrode respectively.

The difference between the laminated structure 5 of the in-cell touch panel FIG. 5 and the laminated structure 3 of the in-cell touch panel FIG. 3 is that the laminated structure 5 further includes the second conductive layer 35 directly formed on the glass layer 34 and the second conductive layer 35 is a transparent conductive layer. The difference between the laminated structure 6 of the in-cell touch panel FIG. 6 and the laminated structure 3 of the in-cell touch panel FIG. 3 is that the laminated structure 6 further includes the second conductive layer 35 disposed on the glass layer 34 in a plug way, wherein the second conductive layer 35 is a transparent conductive layer and a plug module formed by the second conductive layer 35 and the plug component 36 is disposed on the glass layer 34. The difference between the laminated structure 7 of the in-cell touch panel FIG. 7 and the laminated structure 3 of the in-cell touch panel FIG. 3 is that the laminated structure 7 further includes the second conductive layer 35 disposed at the inner side of the glass layer 34, wherein the second conductive layer 35 is a transparent conductive layer formed between the color filter layer 33 and the glass layer 34. The difference between the laminated structure 8 of the in-cell touch panel FIG. 8 and the laminated structure 3 of the in-cell touch panel FIG. 3 is that the laminated structure 8 further includes the second conductive layer 35 disposed at the inner side of the glass layer 34 and the second conductive layer 35 is formed under the color filter layer 33. Since the black matrix resist BM has good light resistance, the second conductive layer 35 arranged in mesh type will be disposed under the black matrix resist BM to be shielded by the black matrix resist BM.

Then, please refer to FIG. 9˜FIG. 12. FIG. 9˜FIG. 12 illustrate different embodiments of the second conductive layer disposed at the inner side or the outer side of the glass layer when the first conductive layer of the hybrid in-cell touch panel is formed before the common electrode respectively.

The difference between the laminated structure 9 of the in-cell touch panel FIG. 9 and the laminated structure 4 of the in-cell touch panel FIG. 4 is that the laminated structure 9 further includes the second conductive layer 45 directly formed on the glass layer 44 and the second conductive layer 45 is a transparent conductive layer. The difference between the laminated structure 10A of the in-cell touch panel FIG. 10 and the laminated structure 4 of the in-cell touch panel FIG. 4 is that the laminated structure 10A further includes the second conductive layer 45 disposed on the glass layer 44 in a plug way, wherein the second conductive layer 45 is a transparent conductive layer and a plug module formed by the second conductive layer 45 and the plug component 46 is disposed on the glass layer 44. The difference between the laminated structure 11A of the in-cell touch panel FIG. 11 and the laminated structure 4 of the in-cell touch panel FIG. 4 is that the laminated structure 11A further includes the second conductive layer 45 disposed at the inner side of the glass layer 44, wherein the second conductive layer 45 is a transparent conductive layer formed between the color filter layer 43 and the glass layer 44. The difference between the laminated structure 12A of the in-cell touch panel FIG. 12 and the laminated structure 4 of the in-cell touch panel FIG. 4 is that the laminated structure 12A further includes the second conductive layer 45 disposed at the inner side of the glass layer 44 and the second conductive layer 45 is formed under the color filter layer 43. Since the black matrix resist BM has good light resistance, the second conductive layer 45 arranged in mesh type will be disposed under the black matrix resist BM to be shielded by the black matrix resist BM.

Then, please refer to FIG. 13˜FIG. 16. FIG. 13˜FIG. 16 illustrate different embodiments of the connection ways of the traces of the switching units in the in-cell touch panel respectively. It should be noticed that the switching unit is disposed out of the active area of the in-cell touch panel, and the switching unit is coupled to the touch electrodes of the in-cell touch panel. The switching unit controls the touch electrodes to be coupled to a signal line or disconnected in the floating state. In addition, a part of the first conductive layer not used as the touch electrodes and electrically connected to the common electrode will be not coupled to the switching unit.

In the embodiment of FIG. 13, the display driver and the touch driver are integrated in the same display/touch driver STIC disposed out of the active area of the in-cell touch panel, and the display driving signal or the touch signal outputted by the display/touch driver STIC can enter into the switching unit SU through the source fan-out SFO also disposed out of the active area of the in-cell touch panel, but not limited to this.

As shown in the dotted-line range R1 of FIG. 13, the display/touch driver STIC can control the switching of the switching unit SU through the control signals CS1 and CS2, so that the display driving signal is inputted into the source line SL of the panel display area to perform frame refresh and the touch sensing line TE is disconnected in the floating state, or the touch signal is inputted into the touch sensing line TE to perform touch sensing and the source line SL is disconnected in the floating state. As shown in the dotted-line range R2 of FIG. 13, the switching unit SU can include a reference voltage signal VREF. When the switching unit SU inputs the display driving signal into the source line SL of the panel display area to perform frame refresh, the switching unit SU will make the touch sensing line TE and the reference voltage signal VREF electrically connected; or when the switching unit SU inputs the touch signal into the touch sensing line TE to perform the touch sensing, the switching unit SU will make the source line SL and the reference voltage signal VREF electrically connected. As shown in the dotted-line range R3 of FIG. 13, the display/touch driver STIC can also directly electrically connected to the touch sensing line TE and electrically connected to the source line SL through the source line fan-out SFO, so that the display driving signal and the touch signal outputted by the display/touch driver STIC can be directly outputted to the source line SL and the touch sensing line TE respectively without any switching unit SU.

In the embodiment of FIG. 14, the display driver IC1 and the touch driver IC2 are separated from each other without being integrated. As shown in the dotted-line range R1 of FIG. 14, the touch driver IC2 can output the control signals CS1 and CS2 to control the switching of the switching unit SU; as shown in the dotted-line range R2 of FIG. 14, the display driver IC1 can also output the control signals CS1 and CS2 to control the switching of the switching unit SU. In addition, as shown in FIG. 13, the switching unit SU in FIG. 14 can include the reference voltage signal VREF or not without any specific limitations.

In the embodiment of FIG. 15, the gate driver and the touch driver are integrated in the same gate/touch driver GTIC, and the display driving signal or the touch signal outputted by the gate/touch driver GTIC can enter into the switching unit SU through the gate fan-out GFO disposed out of the active area of the in-cell touch panel, but not limited to this.

As shown in the dotted-line range R1 of FIG. 15, the gate/touch driver GTIC can control the switching of the switching unit SU through the control signals CS1 and CS2, so that the display driving signal is inputted into the gate line GL of the panel display area to perform frame refresh and the touch sensing line TE is disconnected in the floating state, or the touch signal is inputted into the touch sensing line TE to perform touch sensing and the gate line GL is electrically connected to the reference voltage signal VREF to switch off the TFT components of the in-cell touch panel. As shown in the dotted-line range R2 of FIG. 15, the gate/touch driver GTIC can also directly electrically connected to the touch sensing line TE and electrically connected to the gate line GL through the gate line fan-out GFO, so that the display driving signal and the touch signal outputted by the gate/touch driver GTIC can be directly outputted to the gate line GL and the touch sensing line TE respectively without any switching unit SU.

In the embodiment of FIG. 16, the touch driver IC2 and the gate driver IC3 are separated from each other without being integrated. As shown in the dotted-line range R1 of FIG. 16, the touch driver IC2 can output the control signals CS1 and CS2 to control the switching of the switching unit SU; as shown in the dotted-line range R2 of FIG. 16, the gate driver IC3 can output the control signals CS1 and CS2 to control the switching of the switching unit SU. In addition, as shown in FIG. 15, the switching unit SU in FIG. 16 can include the reference voltage signal VREF or not without any specific limitations.

It should be further noticed that the above-mentioned switching unit SU can be applied to the in-cell self-capacitive touch panel or the in-cell mutual-capacitive touch panel. In addition, it is unnecessary to make all touch electrodes of the in-cell touch panel at the TFT substrate side. For example, a part of touch electrodes can be disposed at the TFT substrate side by using the above-mentioned switch connection way, and other touch electrodes can be disposed at the inner side or the outer side of the glass layer or disposed out of the glass layer in a plug way. In fact, except the above-mentioned condition that the switching unit SU is electrically connected to the touch driver IC2 or the gate driver IC3, there can be other conditions that different switching units SU are electrically connected to the touch driver IC2 and the gate driver IC3 respectively in the same in-cell touch panel, and the detail will be introduced as follows.

Next, different embodiments will be used to explain different switching unit driving methods of the in-cell touch panel of the invention.

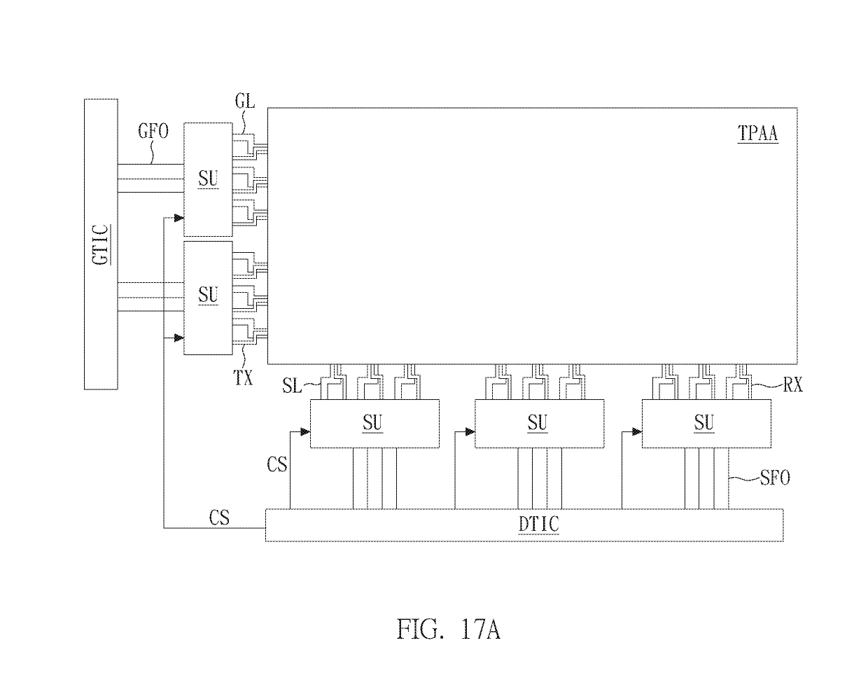

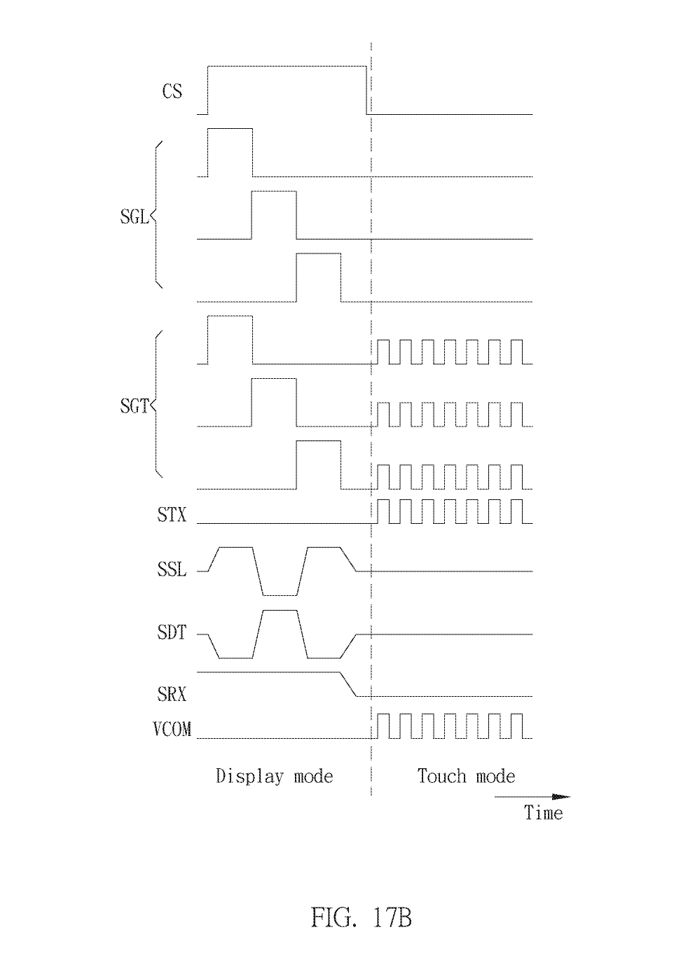

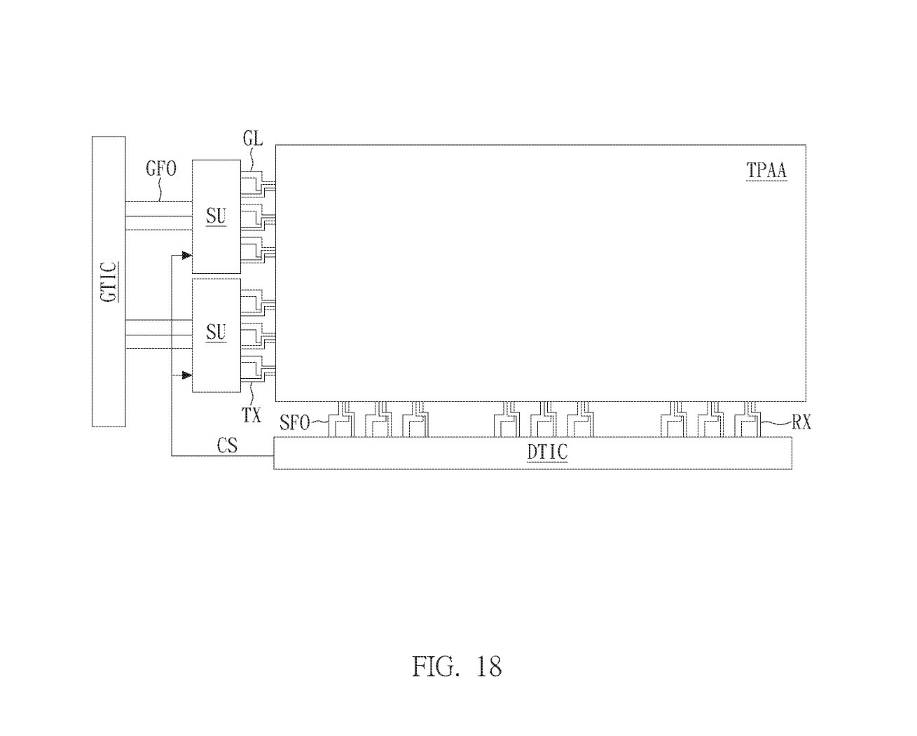

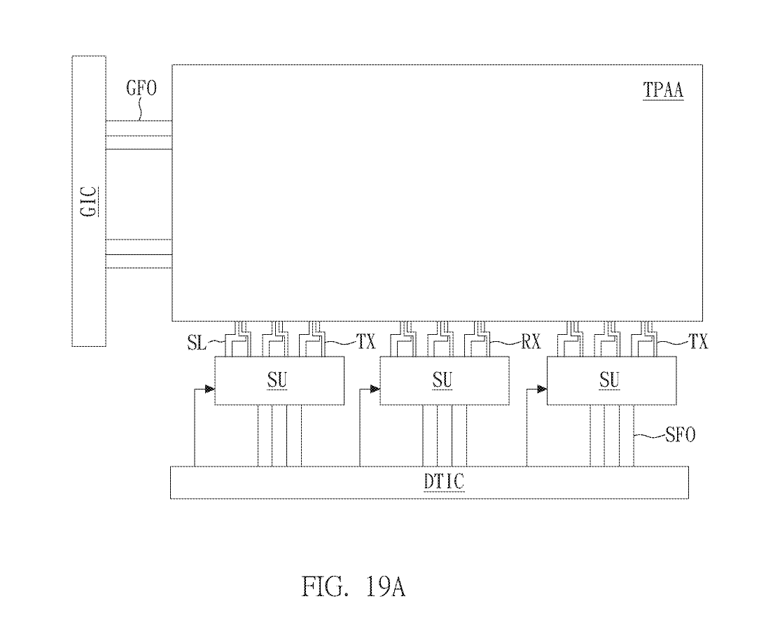

Please refer to FIG. 17A and FIG. 17B. FIG. 17A illustrates a schematic diagram of the first switching unit driving method of the in-cell touch panel of the invention; FIG. 17B illustrates a timing diagram of the signals operated in the display mode and touch sensing mode respectively. As shown in FIG. 17A, the gate driving signal or touch signal SGT outputted by the gate/touch driver GTIC of the in-cell mutual-capacitive touch panel is inputted into the corresponding switching unit SU through the gate line fan-out GFO; the display driving signal or touch signal SDT outputted by the display/touch driver DTIC of the in-cell mutual-capacitive touch panel is inputted into the corresponding switching unit SU through the source line fan-out SFO.

As shown in FIG. 17B, during the display driving period, the display/touch driver DTIC will output the display driving signal and the gate/touch driver GTIC will output the gate control signal. The control signal CS having the first level will be inputted into the switching units SU, and then the switching units SU will electrically connect the gate line fan-out GFO/the source line fan-out SFO to the corresponding gate line GL/source line SL in the in-cell mutual-capacitive touch panel respectively. At the same time, the switching units SU will also electrically connect the touch driving electrode TX/the touch sensing electrode RX to the signal line of the gate line fan-out GFO or the source line fan-out SFO, and the signal provided can be DC voltage, AC voltage, ground voltage or any other electrical signals. In addition, the switching units SU can also disconnect the touch driving electrode TX/the touch sensing electrode RX in the floating state.

During the touch sensing period, the gate/touch driver GTIC will output the touch driving signal and the display/touch driver DTIC will output the touch signal. The control signal CS having the second level will be inputted into the switching units SU, and then the switching units SU will transmit the touch driving signal outputted by the gate/touch driver GTIC to the touch driving electrode TX and electrically connect the gate line GL of the in-cell mutual-capacitive touch panel to an off level to keep the TFT of the panel pixel in an off state. The switching units SU will also transmit the touch signal outputted by the display/touch driver DTIC to the touch sensing electrode RX to perform touch sensing and electrically connect the source line SL to a signal line, and the signal provided can be DC voltage, AC voltage, ground voltage or any other electrical signals. In addition, the switching units SU can also disconnect the source line SL in the floating state.

In fact, the gate/touch driver GTIC can be formed on the substrate through COG (Chip on glass) encapsulation technology, COF (chip on film) encapsulation technology or GOA (Gate driver on array) encapsulation technology, but not limited to this. In addition, there can be the multi-function electrode disposed between the touch driving electrode TX and the touch sensing electrode RX; the multi-function electrode can be electrically connected to the switching unit SU or directly connected to other signal input lines, but not limited to this.

As to the common electrode signal VCOM received by the common electrode CITO, it can be a touch-related voltage signal capable of reducing its RC loading to touch sensing or the common electrode signal VCOM can be kept at DC voltage or in the floating state, but not limited to this. Because the gate line fan-out GFO or the source line fan-out SFO can be used as the signal output line of the touch sensing, then fewer traces can be disposed on the border area of the in-cell mutual-capacitive touch panel to increase the degree of freedom of panel layout and the width of the border area can be reduced to achieve the narrow border effect. In addition, because the pin of the driving IC used to output the display driving signal can be also used to output the touch signal, then the driving IC can connect fewer pins and the size of the driving IC can be also reduced.

Please refer to FIG. 18. FIG. 18 illustrates a schematic diagram of the second switching unit driving method of the in-cell touch panel of the invention. As shown in FIG. 18, only a part of the touch driving electrodes TX/the touch sensing electrodes RX of the in-cell mutual-capacitive touch panel is connected to the switching unit SU and the other touch driving electrodes TX/touch sensing electrodes RX not connecting to the switching unit SU can be directly connected to the touch sensing output terminal of the gate/touch driver GTIC or the display/touch driver DTIC. In this embodiment, the touch driving electrodes TX can be connected to the gate/touch driver GTIC through the switching unit SU and controlled by the switching unit SU; the touch sensing electrodes RX are directly connected to the touch sensing output terminal of the display/touch driver DTIC. As to the method used by the switching unit SU to drive the touch driving electrodes TX, since it is the same with the above-mentioned first switching unit driving method, it will not be repeated here.

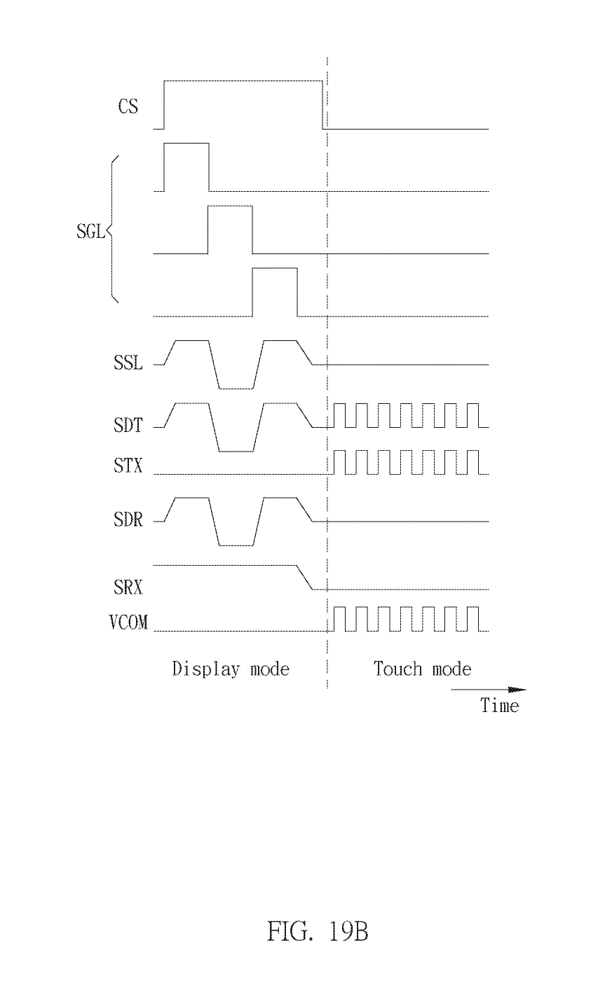

Please refer to FIG. 19A and FIG. 19B. FIG. 19A illustrates a schematic diagram of the third switching unit driving method of the in-cell touch panel of the invention; FIG. 19B illustrates a timing diagram of the signals operated in the display mode and touch sensing mode respectively.

As shown in FIG. 19A, because the gate driver GIC of the in-cell mutual-capacitive touch panel has no touch driving function, the touch driving signal and the touch signal of the in-cell mutual-capacitive touch panel are both outputted by the touch driver DTIC of the in-cell mutual-capacitive touch panel. The display driving signal or the touch signal outputted by the display/touch driver DTIC is inputted into the corresponding switching unit SU through the source line fan-out SFO. As shown in FIG. 19B, during the display driving period, the gate driver GIC will output the gate control signal and the display/touch driver DTIC will output the display driving signal. The control signal CS having the first level is inputted to the switching unit SU, so that the switching unit SU will electrically connect the display driving signal outputted by the display/touch driver DTIC to the source line SL of the in-cell mutual-capacitive touch panel. In addition, the switching unit SU will also electrically connect the touch driving electrode TX/touch sensing electrode RX to the signal line not the source line fan-out SFO, and the signal provided can be DC voltage, AC voltage, ground voltage or any other electrical signals. In addition, the switching units SU can also disconnect the touch driving electrode TX/the touch sensing electrode RX in the floating state.

During the touch sensing period, the gate driver GIC will output a gate switch-off signal and the display/touch driver DTIC will output the touch driving signal/touch signal. At this time, the control signal CS having the second level is inputted into the switching unit SU, so that the switching unit SU will electrically connect the touch driving signal/touch signal outputted by the display/touch driver DTIC to the touch driving electrode TX/the touch sensing electrode RX. In addition, the switching unit SU will also electrically connect the source line SL to a signal line, and the signal provided can be DC voltage, AC voltage, ground voltage or any other electrical signals. In addition, the switching units SU can also disconnect the source line SL in the floating state.

In fact, the gate driver GIC can be formed on the substrate through COG (Chip on glass) encapsulation technology, COF (chip on film) encapsulation technology or GOA (Gate driver on array) encapsulation technology, but not limited to this. The common electrode signal VCOM received by the common electrode CITO can be a touch-related voltage signal capable of reducing its RC loading to touch sensing or the common electrode signal VCOM can be kept at DC voltage or in the floating state, but not limited to this.

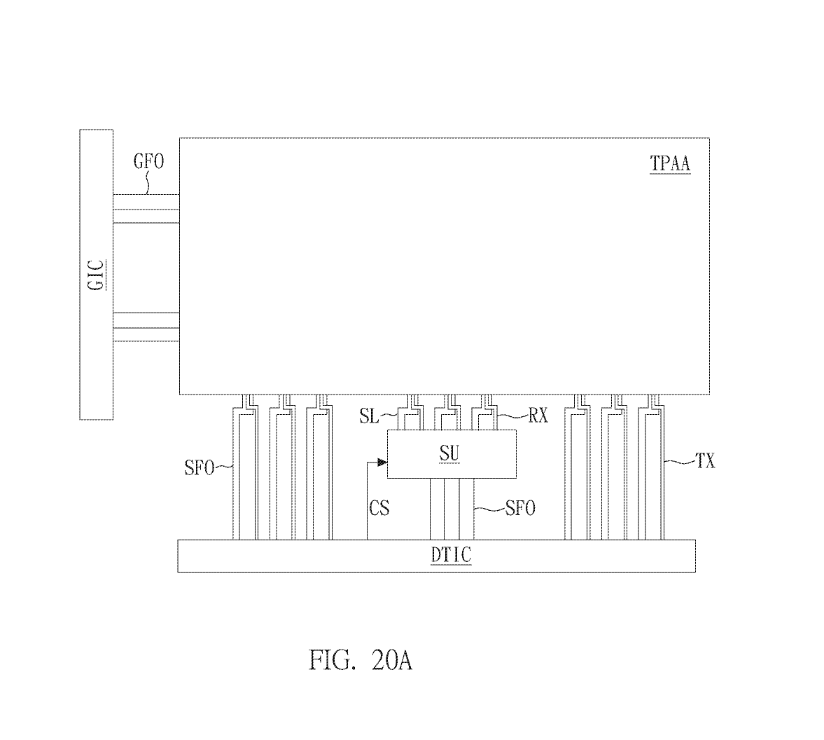

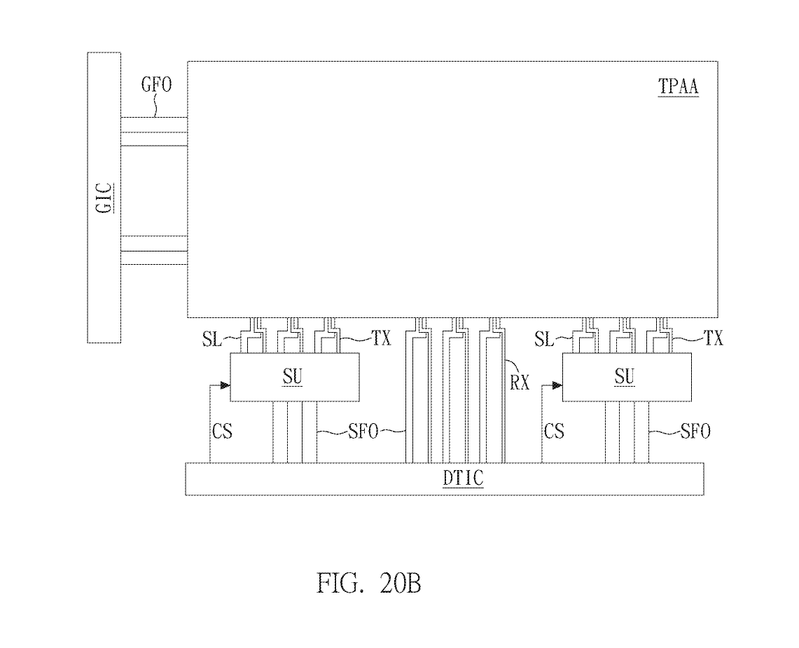

Please refer to FIG. 20A and FIG. 20B. FIG. 20A and FIG. 20B illustrate schematic diagrams of the fourth switching unit driving method of the in-cell touch panel of the invention respectively. As shown in FIG. 20A and FIG. 20B, only a part of the touch driving electrodes TX/the touch sensing electrodes RX of the in-cell mutual-capacitive touch panel is connected to the switching unit SU and the other touch driving electrodes TX/touch sensing electrodes RX not connecting to the switching unit SU can be directly connected to the touch sensing output terminal of the display/touch driver DTIC. As to the method used by the switching unit SU to drive the touch driving electrodes TX, since it is the same with the above-mentioned third switching unit driving method, it will not be repeated here.

As shown in FIG. 20A, the touch driving electrodes TX can directly connect to the touch sensing output terminal of the display/touch driver DTIC; the touch sensing electrodes RX can connect to the display/touch driver DTIC through the switching unit SU and controlled by the switching unit SU. As shown in FIG. 20B, the touch driving electrodes TX can connect to the display/touch driver DTIC through the switching unit SU and controlled by the switching unit SU; the touch sensing electrodes RX can directly connect to the touch sensing output terminal of the display/touch driver DTIC.

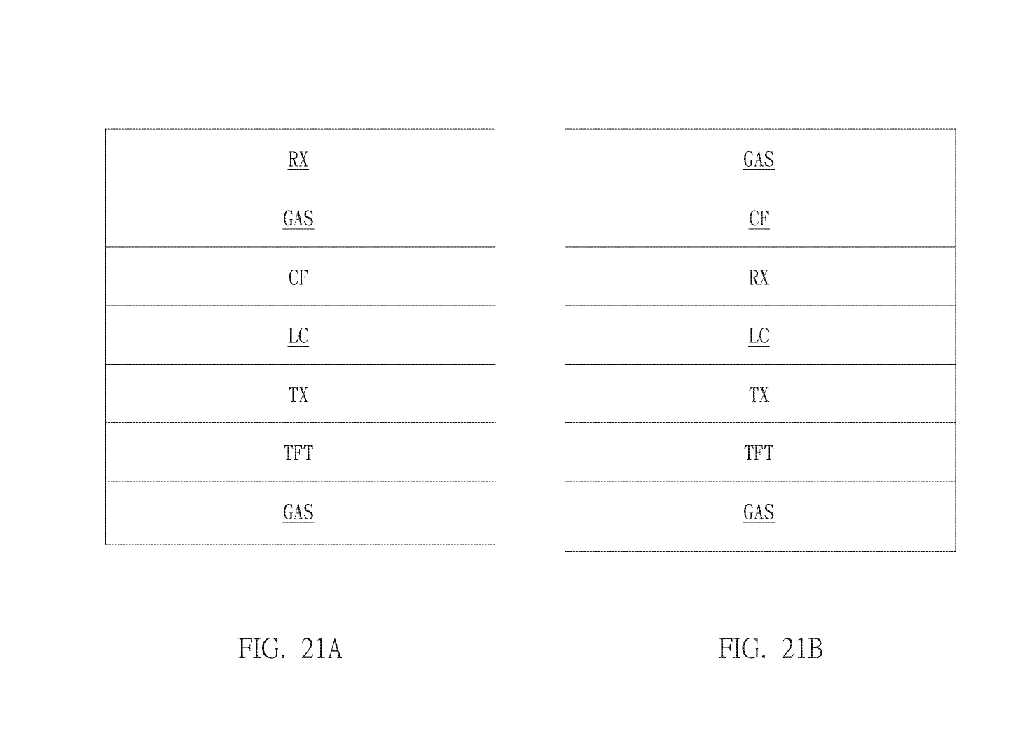

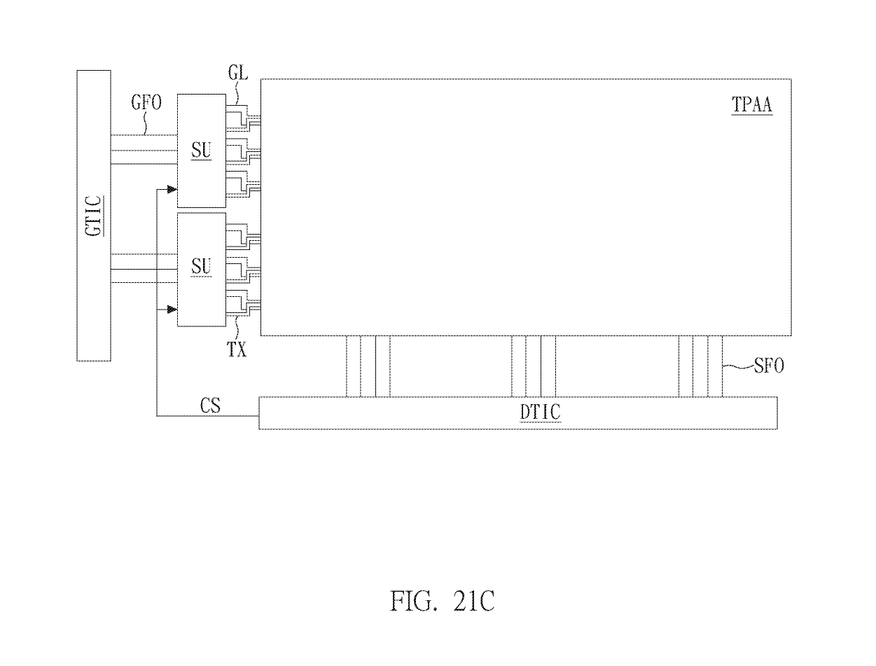

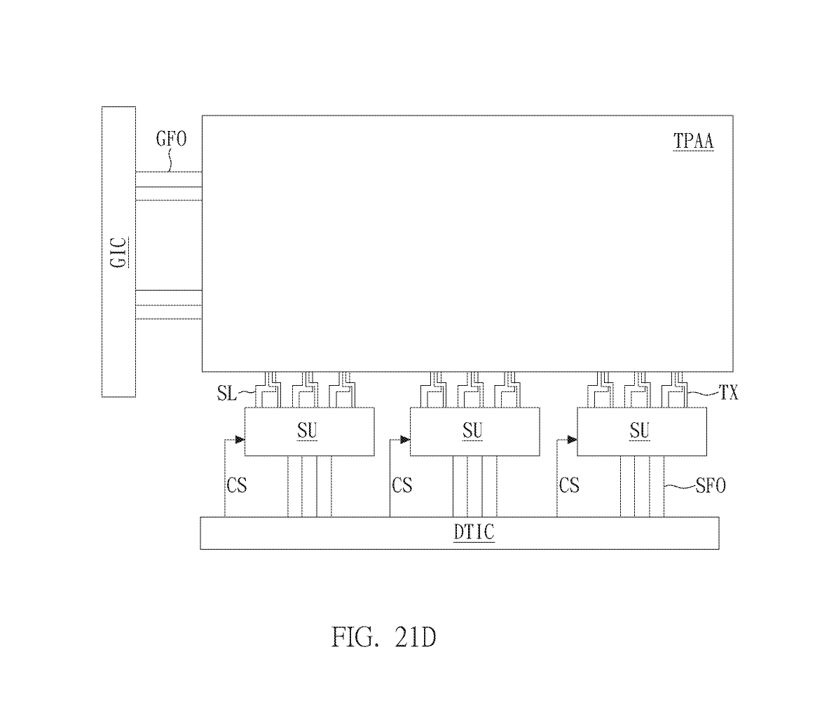

Please refer to FIG. 21A˜FIG. 21D. FIG. 21A˜FIG. 21D illustrate schematic diagrams of the laminated structure and the fifth switching unit driving method of the in-cell touch panel of the invention respectively.

It should be noticed that the in-cell touch panel of this embodiment has a hybrid mutual-capacitive structure, and in its laminated structure, the touch driving electrodes TX can be disposed near the thin-film transistor layer TFT and the touch sensing electrodes RX can be disposed above the color filter CF as shown in FIG. 21A, or the touch driving electrodes TX can be disposed near the thin-film transistor layer TFT and the touch sensing electrodes RX can be disposed under the color filter CF as shown in FIG. 21B.

In practical applications, the touch sensing electrodes RX can be mesh type or formed by the transparent conductive material disposed at the inner side or the outer side of the color filter CF, but not limited to this. When the hybrid in-cell mutual-capacitive touch panel is operated in a touch sensing mode, the touch driving signal can be outputted by the gate/touch driver GTIC as shown in FIG. 21C or outputted by the display/touch driver DTIC as shown in FIG. 21D, but not limited to this.

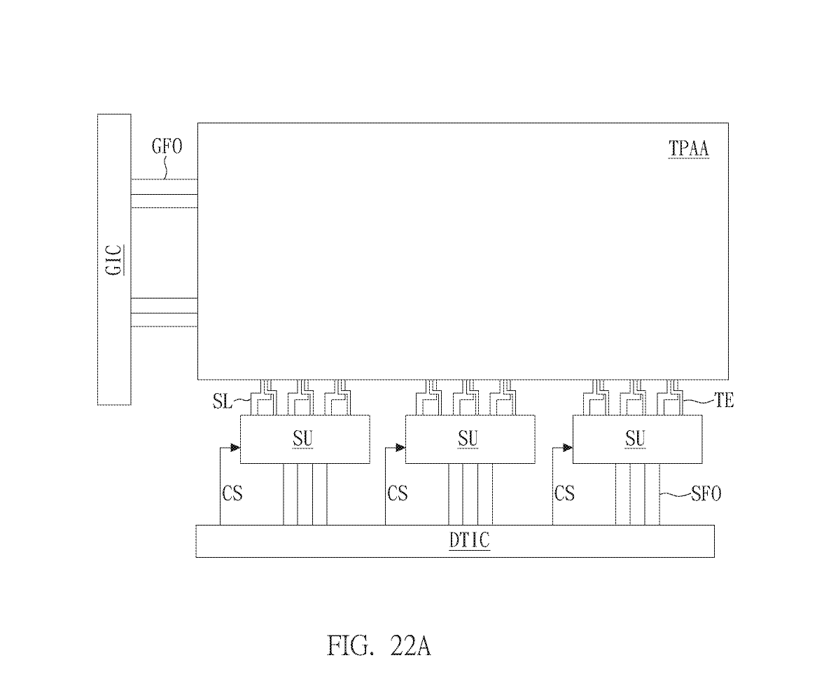

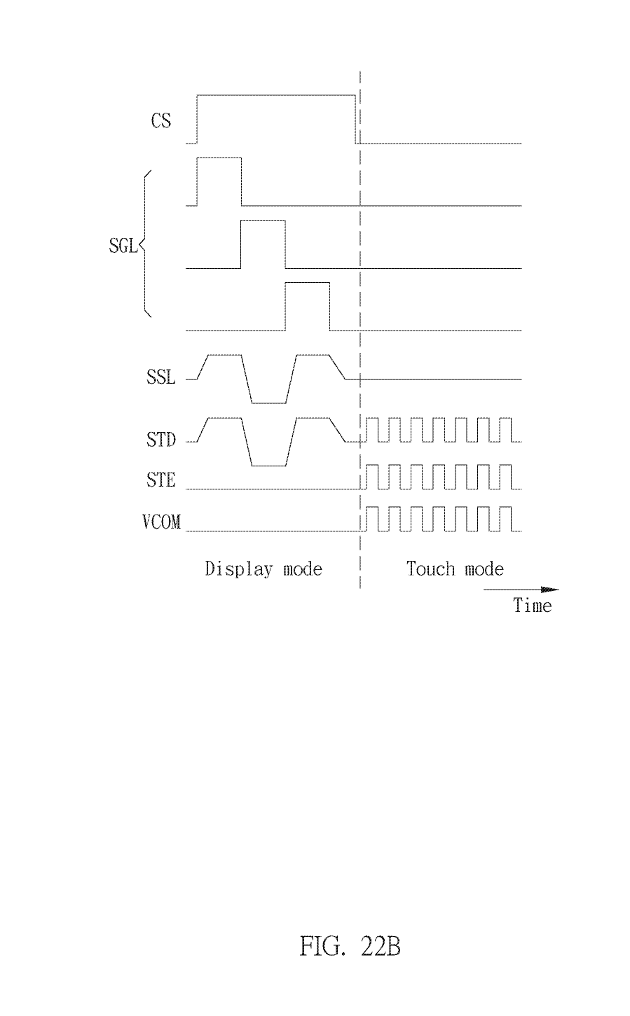

Please refer to FIG. 22A and FIG. 22B. FIG. 22A illustrates a schematic diagram of the sixth switching unit driving method of the in-cell touch panel of the invention; FIG. 22B illustrates a timing diagram of the signals operated in the display mode and touch sensing mode respectively. It should be noticed that the in-cell touch panel of this embodiment is an in-cell self-capacitive touch panel having a self-capacitive sensing structure.

As shown in FIG. 22A, because the gate driver GIC of the in-cell self-capacitive touch panel has no touch driving function, the display driving signal and the touch signal of the in-cell self-capacitive touch panel are both outputted by the touch driver DTIC of the in-cell self-capacitive touch panel and then inputted into the corresponding switching unit SU through the source line fan-out SFO. As shown in FIG. 22B, during the display driving period, the gate driver GIC will output the gate control signal and the display/touch driver DTIC will output the display driving signal. The control signal CS having the first level is inputted to the switching unit SU, so that the switching unit SU will electrically connect the display driving signal outputted by the display/touch driver DTIC to the source line SL of the in-cell self-capacitive touch panel. In addition, the switching unit SU will also electrically connect the source line SL to the signal line not the source line fan-out SFO, and the signal provided can be DC voltage, AC voltage, ground voltage or any other electrical signals. In addition, the switching units SU can also disconnect the source line SL in the floating state.

During the touch sensing period, the gate driver GIC will output a gate switch-off signal and the display/touch driver DTIC will output the touch signal. At this time, the control signal CS having the second level is inputted into the switching unit SU, so that the switching unit SU will electrically connect the touch signal outputted by the display/touch driver DTIC to the source line SL. In addition, the switching unit SU will also electrically connect the source line SL to a signal line, and the signal provided can be DC voltage, AC voltage, ground voltage or any other electrical signals. In addition, the switching units SU can also disconnect the source line SL in the floating state.

In fact, the gate driver GIC can be formed on the substrate through COG encapsulation technology, COF encapsulation technology or GOA encapsulation technology, but not limited to this. The common electrode signal VCOM received by the common electrode CITO can be a touch-related voltage signal capable of reducing its RC loading to touch sensing or the common electrode signal VCOM can be kept at DC voltage or in the floating state, but not limited to this.

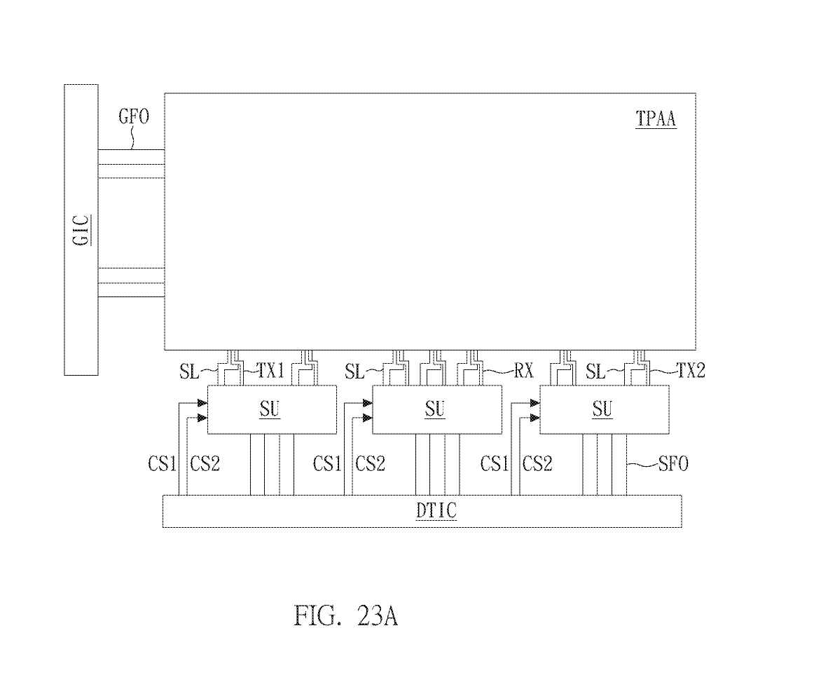

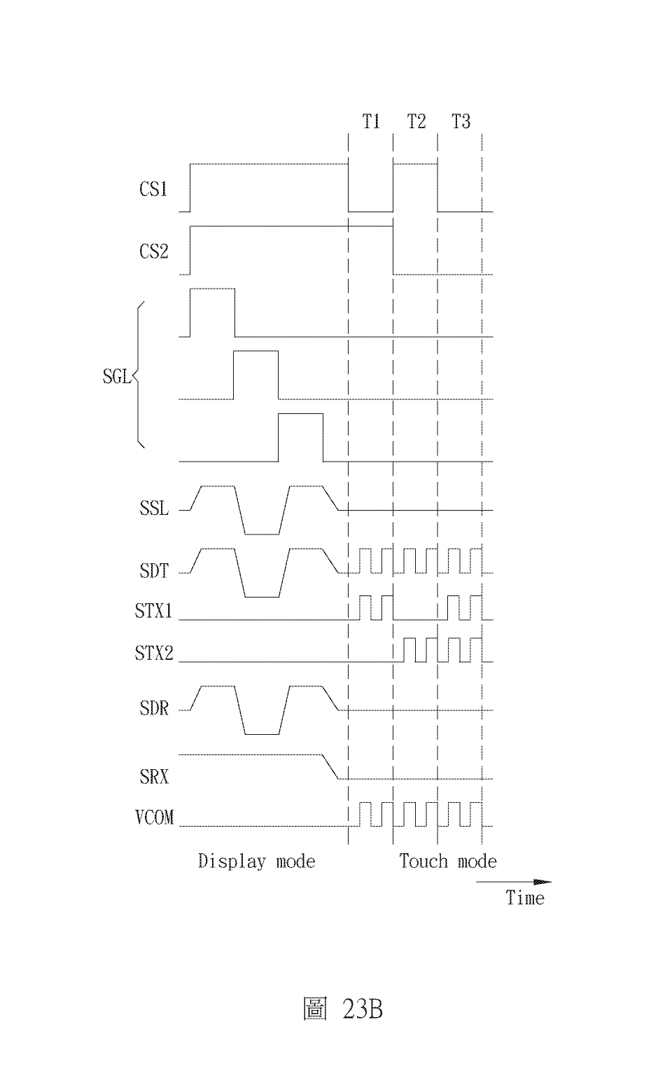

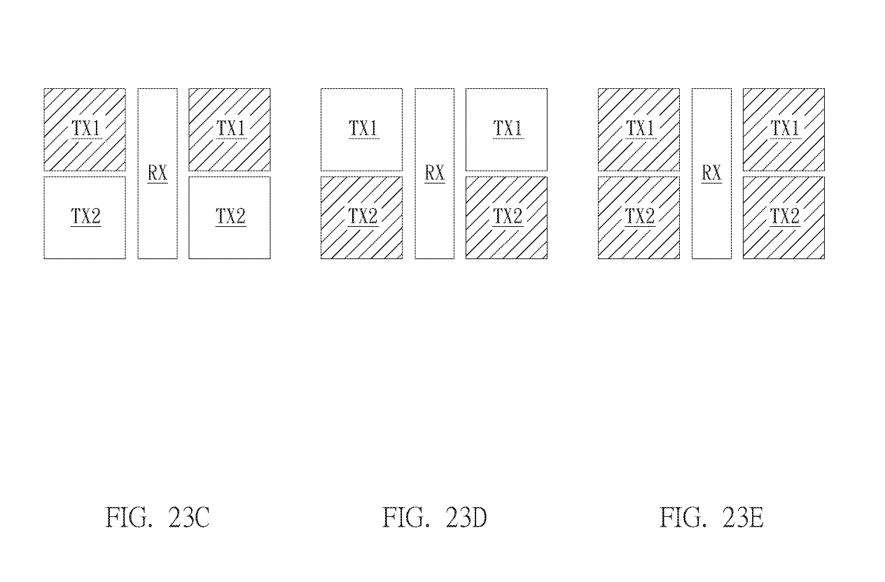

Please refer to FIG. 23A˜FIG. 23E. FIG. 23A˜FIG. 23E illustrate a schematic diagram of the seventh switching unit driving method of the in-cell touch panel of the invention, a timing diagram of the signals operated in the display mode and touch sensing mode respectively and a schematic diagram of the touch electrode driving condition under different touch times. It should be noticed that the in-cell mutual-capacitive touch panel of this embodiment can use different operating ways such as a combined touch sensing or a zoning touch sensing.

As shown in FIG. 23A, the display driving signal or touch signal outputted by the display/touch driver DTIC is inputted into the corresponding switching unit SU through the source line fan-out SFO. It should be noticed that the switching unit SU can not only switch the connection between the touch electrodes and the gate line fan-out GFO/the source line fan-out SFO, but also switch among different touch electrode sets. Each switching unit SU is controlled by two control signals CS1 and CS2, so that the same gate line fan-out GFO/source line fan-out SFO can selectively transmit the touch signal to different touch electrodes at the same time, or only transmit the touch signal to a part of the touch electrodes to achieve the combined touch sensing function or the zoning touch sensing function. Since the same output channel can be shared by different touch electrodes, the number of the components in the touch IC can be further reduced.

As shown in FIG. 23B, during the display driving period, the gate driver GIC will output the gate control signal and the display/touch driver DTIC will output the display driving signal. The switching unit SU will electrically connect the display driving signal outputted by the display/touch driver DTIC to the source line SL of the in-cell mutual-capacitive touch panel. In addition, the switching unit SU will electrically connect the touch driving electrodes TX/the touch sensing electrodes RX to the signal line not the source line fan-out SFO, and the signal provided can be DC voltage, AC voltage, ground voltage or any other electrical signals. In addition, the switching units SU can also disconnect the touch driving electrodes TX/the touch sensing electrodes RX in the floating state.

During the touch sensing period, in the first period of sensing time T1, the control signal CS1 having the second level makes the first touch driving electrodes TX1 connected to the touch signal input terminal and the control signal CS2 having the first level makes the second touch driving electrodes TX2 connected to the signal line not for touch sensing or disconnected. At this time, as shown in FIG. 23C, the touch sensing area only includes the shaded area portions covered by the first touch driving electrodes TX1; therefore, it is the zoning touch sensing performed in the first period of sensing time T1. In the second period of sensing time T2, the control signal CS2 having the second level makes the second touch driving electrodes TX2 connected to the touch signal input terminal and the control signal CS1 having the first level makes the first touch driving electrodes TX1 connected to the signal line not for touch sensing or disconnected. At this time, as shown in FIG. 23D, the touch sensing area only includes the shaded area portions covered by the second touch driving electrodes TX2; therefore, it is the zoning touch sensing performed in the second period of sensing time T2. In the third period of sensing time T3, the control signals CS1 and CS2 both having the second level make the first touch driving electrodes TX1 and the second touch driving electrodes TX2 connected to the same touch signal input terminal. At this time, as shown in FIG. 23E, the touch sensing area includes all the shaded area portions covered by the first touch driving electrodes TX1 and the second touch driving electrodes TX2; therefore, it is the combined touch sensing performed in the third period of sensing time T3. It should be noticed that the practical order of driving the touch driving electrodes is not limited by the above-mentioned embodiments and the combined touch sensing can be performed or not.

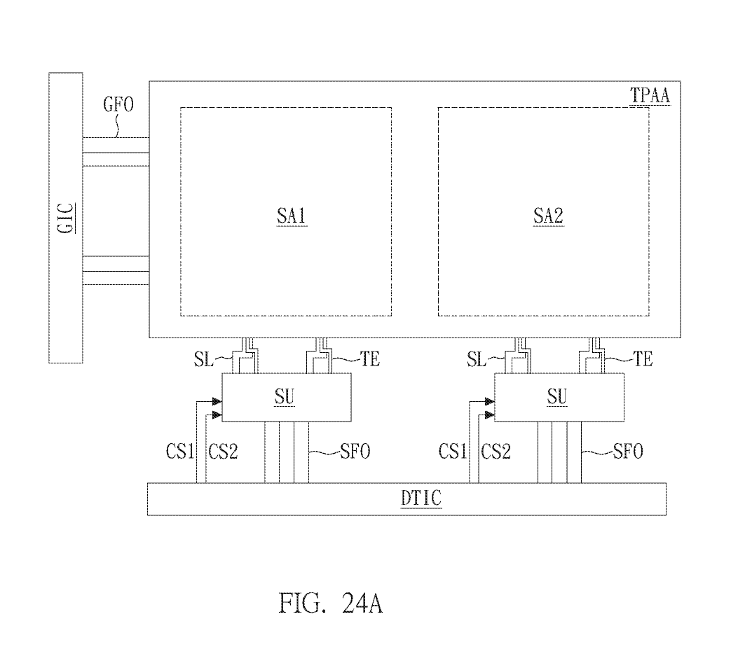

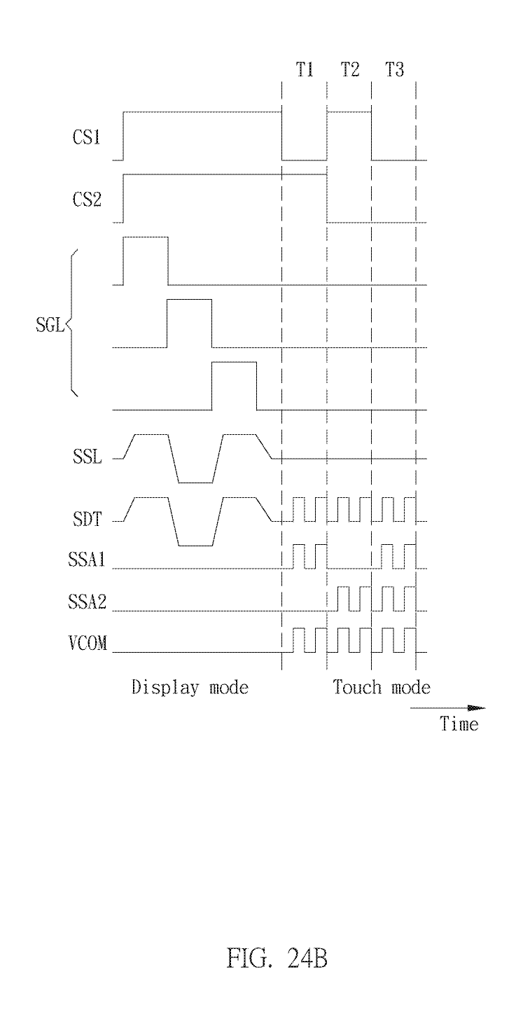

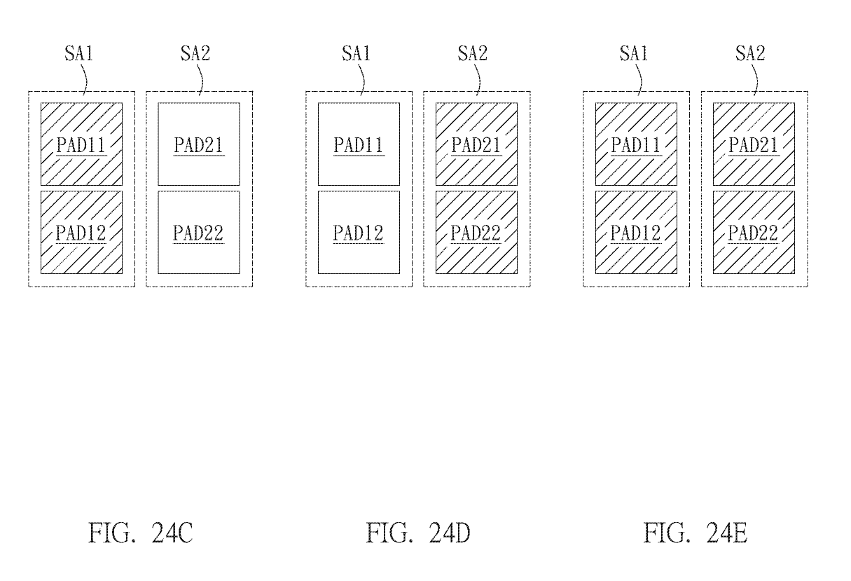

Please refer to FIG. 24A˜FIG. 24E. FIG. 24A˜FIG. 24E illustrate a schematic diagram of the eighth switching unit driving method of the in-cell touch panel of the invention, a timing diagram of the signals operated in the display mode and touch sensing mode respectively and a schematic diagram of the touch electrode driving condition under different touch times. It should be noticed that the in-cell mutual-capacitive touch panel of this embodiment can use different operating ways such as a combined touch sensing or a zoning touch sensing.

As shown in FIG. 24A, the switching unit SU can not only switch the connection between the touch electrodes and the source line fan-out SFO, but also switch among different touch electrodes. Each switching unit SU is controlled by two control signals CS1 and CS2, so that the same source line fan-out SFO can selectively transmit the touch signal to different touch electrodes at the same time, or only transmit the touch signal to a part of the touch electrodes to achieve the combined touch sensing function or the zoning touch sensing function. Since the same output channel can be shared by different touch electrodes, the number of the components in the touch IC can be further reduced.

During the display driving period, the gate driver GIC will output the gate control signal and the display/touch driver DTIC will output the display driving signal. The switching unit SU will electrically connect the display driving signal outputted by the display/touch driver DTIC to the source line SL of the in-cell mutual-capacitive touch panel. In addition, the switching units SU will also electrically connect the touch electrodes TE to the signal lines not for the source line fan-out SFO, and the signal provided can be DC voltage, AC voltage, ground voltage or any other electrical signals. In addition, the switching units SU can also disconnect the touch electrodes TE in the floating state.

During the touch sensing period, in the first period of sensing time T1, the control signal CS1 having the second level makes the touch electrodes of the first sensing area SA1 connected to the touch signal input terminal and the control signal CS2 having the first level makes the touch electrodes of the second sensing area SA2 connected to the signal line not for touch sensing or disconnected. At this time, as shown in FIG. 24C, the touch sensing area only includes the shaded area portions covered by the first sensing area SA1 (the sensing pads PAD11 and PAD12); therefore, it is the zoning touch sensing performed in the first period of sensing time T1. In the second period of sensing time T2, the control signal CS2 having the second level makes the touch electrodes of the second sensing area SA2 connected to the touch signal input terminal and the control signal CS1 having the first level makes the touch electrodes of the first sensing area SA1 connected to the signal line not for touch sensing or disconnected. At this time, as shown in FIG. 24D, the touch sensing area only includes the shaded area portions covered by the second sensing area SA2 (the sensing pads PAD21 and PAD22); therefore, it is the zoning touch sensing performed in the second period of sensing time T2. In the third period of sensing time T3, the control signals CS1 and CS2 both having the second level make the touch electrodes of the first sensing area SA1 and the second sensing area SA2 connected to the same touch signal input terminal. At this time, as shown in FIG. 24E, the touch sensing area includes all the shaded area portions covered by the first sensing area SA1 and the second sensing area SA2 (all the sensing pads PAD11, PAD12, PAD21 and PAD22); therefore, it is the combined touch sensing performed in the third period of sensing time T3. It should be noticed that the practical order of driving the touch driving electrodes is not limited by the above-mentioned embodiments and the combined touch sensing can be performed or not.

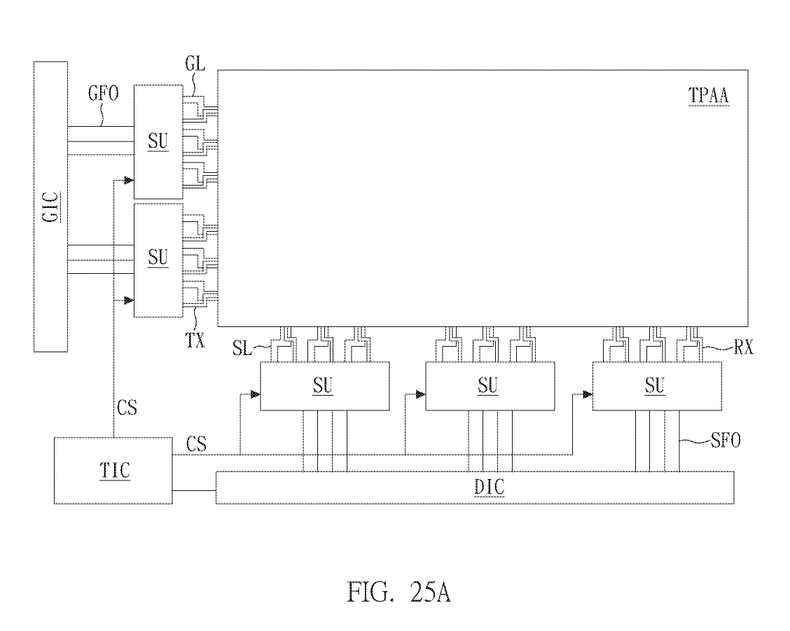

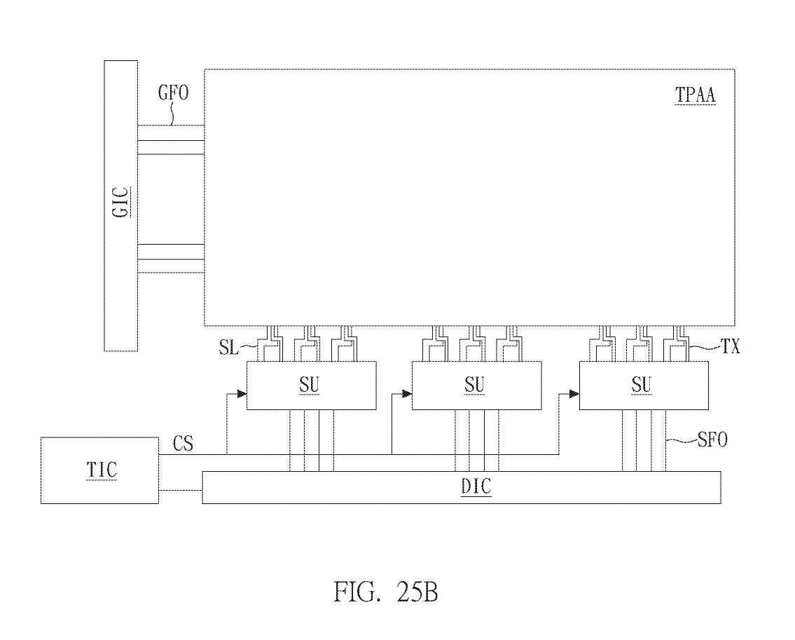

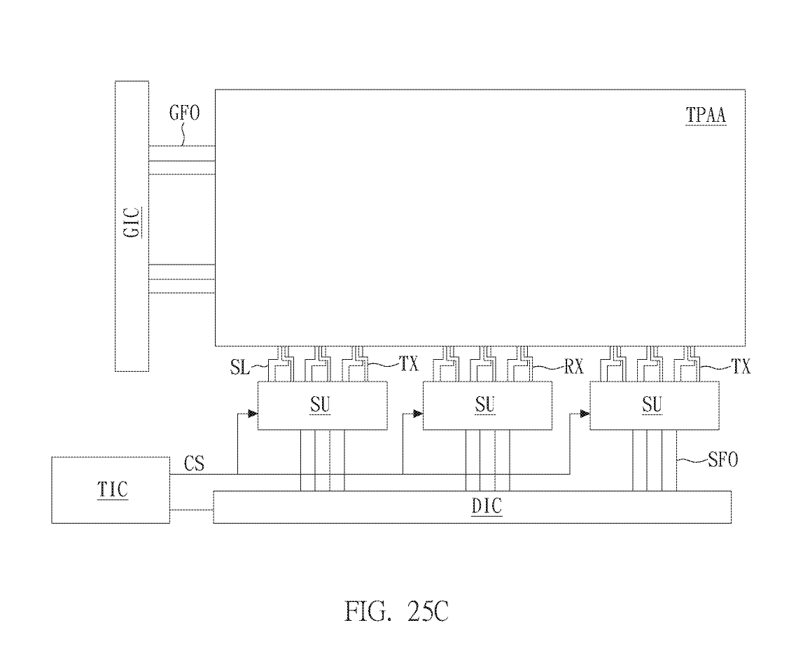

Except the above-mentioned embodiments of integrating the touch driver into the gate driver and/or the display driver, in practical applications, as shown in FIG. 25A˜FIG. 25C, the touch driver TIC can be independently disposed out of the gate driver GIC and display driver DIC in the in-cell touch panel having the mutual-capacitive bridging structure, the hybrid mutual-capacitive structure and the single-layer mutual-capacitive structure respectively. In an embodiment, the touch driver TIC can be formed on the substrate through COG encapsulation technology, COF encapsulation technology or GOA encapsulation technology, but not limited to this.

Above all, compared to the prior art, the in-cell touch panel of the invention has the following advantages:
(1) The designs of the touch electrodes and their traces are simple.
(2) The original aperture ratio of the display apparatus is not affected by its layout method.
(3) The RC loading of the common electrode can be reduced.
(4) When the in-cell touch panel is operated in the touch mode, the common electrode will be controlled at the same time to reduce the entire RC loading of the in-cell touch panel.
(5) The touch mode and the display mode are driven in a time-sharing way to enhance the signal-noise ratio (SNR).
(6) The number of traces can be reduced to increase the degree of freedom of layout and the narrow border effect can be achieved.
(7) Less IC pins will be used.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. An in-cell touch panel, comprising:
a plurality of pixels, and a laminated structure of each pixel comprising:
a substrate;
a TFT layer disposed on the substrate, wherein a first conductive layer and a common electrode are disposed in the TFT layer, and the first conductive layer is arranged in mesh type or arranged along a first direction within an active area of the in-cell touch panel;
a liquid crystal layer disposed above the TFT layer;
a color filter layer disposed above the liquid crystal layer; and
a glass layer disposed above the color filter layer.

2. The in-cell touch panel of claim 1, wherein the in-cell touch panel is an in-cell self-capacitive touch panel or an in-cell mutual-capacitive touch panel.

3. The in-cell touch panel of claim 1, wherein touch electrodes of the in-cell touch panel is formed by the first conductive layer arranged in mesh type.

4. The in-cell touch panel of claim 1, wherein the first conductive layer and the common electrode are separated by an insulating layer.

5. The in-cell touch panel of claim 1, wherein a part of the first conductive layer not forming touch electrodes is electrically connected with the common electrode through a via.

6. The in-cell touch panel of claim 1, wherein the first conductive layer is formed after the common electrode.

7. The in-cell touch panel of claim 1, wherein the first conductive layer is formed before the common electrode.

8. The in-cell touch panel of claim 1, wherein the color filter layer comprises a color filter and a black matrix resist having good light resistance, and the first conductive layer is disposed under the black matrix resist.

9. The in-cell touch panel of claim 1, wherein if the in-cell touch panel is a hybrid in-cell touch panel, then the laminated structure further comprises a second conductive layer disposed at an inner side or an outer side of the glass layer, and the second conductive layer is arranged in mesh type or arranged along a second direction within the active area of the in-cell touch panel.

10. The in-cell touch panel of claim 9, wherein the first conductive layer and the second conductive layer form a plurality of first direction touch electrodes and a plurality of second direction touch electrodes of the in-cell touch panel respectively.

11. The in-cell touch panel of claim 10, wherein the plurality of first direction touch electrodes is touch driving electrodes and the plurality of second direction touch electrodes is touch sensing electrodes, or the plurality of first direction touch electrodes is touch sensing electrodes and the plurality of second direction touch electrodes is touch driving electrodes.

12. The in-cell touch panel of claim 10, wherein at least one multi-functional electrode is disposed between the plurality of first direction touch electrodes and the plurality of second direction touch electrodes.

13. The in-cell touch panel of claim 9, wherein the color filter layer comprises a color filter and a black matrix resist having good light resistance, and when the second conductive layer is arranged in mesh type and disposed at the inner side of the glass layer, the second conductive layer is disposed under the black matrix resist.

14. The in-cell touch panel of claim 9, wherein when the second conductive layer is disposed at the inner side of the glass layer, the second conductive layer is a transparent conductive layer formed between the color filter layer and the glass layer.

15. The in-cell touch panel of claim 9, wherein when the second conductive layer is disposed at the outer side of the glass layer, the second conductive layer is a transparent conductive layer directly formed on the glass layer or disposed on the glass layer in a plug way.

16. The in-cell touch panel of claim 5, wherein a switching unit is disposed out of the active area of the in-cell touch panel, and the part of the first conductive layer not forming touch electrodes and electrically connecting with the common electrode is not coupled to the switching unit.

17. The in-cell touch panel of claim 1, wherein a switching unit is disposed out of the active area of the in-cell touch panel, and the switching unit is coupled to a plurality of touch electrodes of the in-cell touch panel to control the plurality of touch electrodes to be coupled to a signal line or to be disconnected in a floating state.

18. The in-cell touch panel of claim 17, wherein the signal line is a source line fan-out or a gate line fan-out disposed out of the active area.

19. The in-cell touch panel of claim 17, wherein when the plurality of touch electrodes is coupled to the signal line, a touch signal, a DC (Direct current) signal or a ground signal can be inputted through the signal line.

20. The in-cell touch panel of claim 17, wherein the switching unit comprises a reference voltage signal, when the plurality of touch electrodes is disconnected, the plurality of touch electrodes is electrically connected with the reference voltage signal.

21. The in-cell touch panel of claim 17, wherein the switching unit controls the signal line to output a touch signal to all or a part of the plurality of touch electrodes to achieve a combined touch sensing function or a zoning touch sensing function respectively.

22. The in-cell touch panel of claim 1, wherein a switching unit is disposed out of the active area of the in-cell touch panel, and the switching unit is coupled to a source line or a gate line in the active area of the in-cell touch panel to control the source line or the gate line to be coupled to a display control signal input terminal or a other signal input terminal.

23. The in-cell touch panel of claim 22, wherein the display control signal input terminal is a source line fan-out or a gate line fan-out.

24. The in-cell touch panel of claim 22, wherein the other signal input terminal is a signal line and a DC (Direct current) signal, an AC (Alternating current) signal, a ground signal or a floating signal can be inputted through the signal line.

25. The in-cell touch panel of claim 17, wherein the switching unit comprises a reference voltage signal, when the source line or the gate line is disconnected, the source line or the gate line is electrically connected with the reference voltage signal.

26. The in-cell touch panel of claim 1, wherein at least one driver is disposed out of the active area of the in-cell touch panel and the at least one driver is formed by integrating a display driver and a touch driver or the display driver and the touch driver are disposed independently.

27. The in-cell touch panel of claim 26, wherein a plurality of touch electrodes of the in-cell touch panel is all coupled to the at least one driver through a plurality of switching units disposed out of the active area of the in-cell touch panel.

28. The in-cell touch panel of claim 26, wherein a part of the touch electrodes of the in-cell touch panel is coupled to the at least one driver through a plurality of switching units disposed out of the active area of the in-cell touch panel, and another part of the touch electrodes of the in-cell touch panel is directly coupled to the at least one driver.

29. The in-cell touch panel of claim 1, wherein the at least one driver is formed on the substrate through COG (Chip on glass) encapsulation technology, COF (chip on film) encapsulation technology or GOA (Gate driver on array) encapsulation technology.
